(19) United States
(12) Patent Application Publication
(10) Pub. No.: US 2026/0350820 A1
(43) Pub. Date: Nov. 5, 2026

(54) DYNAMIC OBJECT TRACKING IN PORTABLE PLAYING SPACE

(71) Applicant: TOCA Football, Inc., Costa Mesa, CA (US)

(72) Inventor: Conrad Spiteri, Thames Ditton (GB)

(21) Appl. No.: 19/665,568

(22) Filed: May 1, 2026

Related U.S. Application Data
(60) Provisional application No. 63/799,197, filed on May 2, 2025.

(51) Int. Cl. G06T 7/292; G06T 7/11; G06V 10/10; G06V 10/26; G06V 10/764; G06V 20/40; G06V 20/60; G06V 40/10; H04N 23/90

(52) U.S. Cl. CPC G06T 7/292; G06T 7/11; G06V 10/16; G06V 10/26; G06V 10/764; G06V 20/42; G06V 20/60; G06V 40/10; H04N 23/90; G06T 2207/10016; G06T 2207/20212; G06T 2207/30196; G06T 2207/30224

(57) ABSTRACT

An object tracking system includes a pair of vertical camera arrays, a processor, and a non-transitory computer-readable storage medium in communicative communication with one another. Each vertical camera array is disposed on or adjacent to a first face of a playing space and includes two time-synchronized cameras arranged vertically. The storage medium includes logic executable by the processor to perform operations including obtaining a set of images from the cameras of the vertical camera arrays, identifying an object in the set of images based on object recognition processing, determining a disposition of the object within the playing space, selecting a sequence of image pairs within the set of images, and using the sequence to track the location of the object.

### CROSS-REFERENCE TO RELATED APPLICATIONS

This application claims priority to U.S. Provisional Patent Application No. 63/799,197, filed May 2, 2025, entitled “Dynamic Object Tracking In Portable Playing Space,” which is incorporated by reference in its entirety into this application

### TECHNICAL FIELD

The disclosure relates generally to object tracking and in particular to the design and functionality of a portable playing space for dynamically tracking an object.

### BACKGROUND

In various sports, to be in control of the ball is of importance to every level of player. The ability to control an awkward bouncing or awkwardly thrown or launched ball quickly and effectively gives the player with the ball the immediate advantage. A player's first touch is often the difference between success and failure in most situations within a sporting event. Additionally, accuracy in passing and shooting a ball is essential in developing a well-rounded game in most sports. As players develop in skill, the level of competition increases, which typically results in an increase in the speed of game situations thereby demanding more speed from the player. Consequently, there is a greater need for accurate and precise interactions with a ball, such as accurate shooting and passing. Often, players cannot always place a ball, either to score a goal or even to place a shot or pass within a specific location of the goal (or desired location)—e.g., out of the reach of the goalie; therefore, a player may miss out on an opportunity to score points or assist a teammate.

Players can improve the accuracy of their shooting and passing by performing shooting and passing drills. Often, however, a player is unable to concentrate on keeping track of the location of each pass or shot within a goal or other area during drills involving several balls. Therefore, by the end of the drill, a player typically does not remember his/her accuracy and cannot determine whether he/she is improving based on results of previous drills. Additionally, although players may utilize video recording to review their training sessions or game play, a player may not understand the proper mechanics of performing certain moves or drills, and as a result, fail to learn anything from merely watching a video recording. Video recording technologies exist in which a video is captured of a ball (such as a golf ball) being hit from a static position with computer analysis performed on the player's swing. However, most sports are not limited to hitting a static ball; therefore, current technologies used to analyze a golf swing cannot be applied to analyze all aspects of other sports in which a critical component of the game is receiving a moving object.

In addition to the aim of many athletes to improve their performance within a specific sport, there is a large portion of the world population that enjoys sports and participates recreationally as opposed to competitively. This portion of the population may desire to participate in sport-like activities that do not necessarily require fully suiting up and participating in an organized, or even unorganized, sporting match. Using soccer, or football as it is referred to throughout most of the world, as one example, a person or groups of persons may desire to recreationally kick a soccer ball around or at a goal within a social atmosphere. Further, this group of persons may desire to compete against each other in ways such as determining who can most accurately kick a set of balls without having to chase after missed shots or collect kicked balls.

Additionally, this person or group of persons may desire to have their experience incorporate some form of video technology that enables simulation of various scenarios, such as simulating taking a penalty shot against a famous goalkeeper. Even further, this person or group of persons may desire to see a replay of their interactions with the ball.

Various shortcomings of current technologies with respect to the above can make difficult object tracking, such as accurately tracking a soccer ball; metrics tracking, such as accurately recording a player’s performance during a training drill; and replay generation, such as accurately generating and correlating replay videos to training drills, among other difficulties. These difficulties are further exacerbated when constraints are imposed on the playing space, such as size or construction constraints.

### SUMMARY

Disclosed herein is an object tracking system, in accordance with some embodiments. The object tracking system includes a pair of vertical camera arrays disposed adjacent to or on a first face of a playing space. Each vertical camera array comprises two cameras arranged vertically within the vertical camera array, and the cameras of the pair of vertical camera arrays are time-synchronized. The object tracking system also includes a processor communicatively coupled to the cameras of the pair of vertical camera arrays. The object tracking system also includes a non-transitory computer-readable storage medium having stored thereon logic that, when executed by the processor, causes performance of operations. The operations include obtaining a set of images from the cameras of the vertical camera arrays. The set of images comprises a first sequence of image pairs captured at successive times by the cameras of one of the vertical camera arrays, and a second sequence of image pairs captured at the successive times by the cameras of the other vertical camera array. The operations further include identifying an object in the set of images based on object recognition processing. The operations further include determining whether the object is disposed in a first portion of the playing space or in a second portion of the playing space. The playing space comprises a floor surface area proximate to the first face, and the first portion and the second portion divide the floor surface area along a midline perpendicular to a midpoint of the first face. The operations further include selecting either the first sequence of image pairs or the second sequence of image pairs based on the determination of whether the object is disposed in the first portion of the playing space or the second portion of the playing space. The operations further include tracking a location of the object within the playing space over time using the selected sequence of image pairs. The tracking comprises triangulating the location of the object at one of the successive times.

In some embodiments, the pair of vertical camera arrays includes a first vertical camera array and a second vertical camera array, the first vertical camera array is disposed adjacent to the first face of the playing space on a side of the midline corresponding to the first portion of the playing space, the second vertical camera array is disposed adjacent to the first face of the playing space on a side of the midline corresponding to the second portion of the playing space, the first sequence of image pairs are captured by the first vertical camera array and include images of the second portion of the playing space, and the second sequence of image pairs are captured by the second vertical camera array and include images of the first portion of the playing space.

In some embodiments, each vertical camera array additionally comprises a third camera vertically positioned between the two cameras of the vertical camera array, and the operations further comprise obtaining a second set of images from the third cameras of the vertical camera arrays, the second set of images comprising replay image pairs captured at the successive times by the third cameras; stitching at least some of the replay image pairs together, resulting in a set of panoramic replay images; and displaying the set of panoramic replay images as a video on a screen of the object tracking system.

In some embodiments, each of the cameras of each vertical camera array is disposed such that a wider dimension of an aspect ratio of the camera is vertical, where the aspect ratio of the camera includes a wider dimension and a perpendicular less-wide dimension, and each of the cameras of each vertical camera array includes in a respective field of view at least part of a floor surface area of the playing space and at least part of a ceiling surface area of the playing space.

In some embodiments, the processor and the non-transitory computer-readable storage medium are components of a ruggedized computing device disposed proximate to the vertical camera arrays, the processor comprises a central processing unit (CPU) and a plurality of graphics processing units (GPUs), and the cameras of the vertical camera arrays are physically wired to the computing device.

In some embodiments, the object recognition processing comprises applying the set of images to an artificial intelligence (AI) classifier model trained on historic images taken by the cameras of the vertical camera arrays, resulting in an image segmentation of the object within at least some images of the set of image.

In some embodiments, the cameras of the vertical camera arrays are angled towards a point on the midline of the floor surface area such that fields of view of the cameras overlap.

In some embodiments, triangulating the location of the object at one of the successive times comprises applying a particular image pair, from the selected sequence of image pairs, that corresponds to the one of the successive times, to an artificial intelligence (AI) classifier model, resulting in image segmentations of the object and one or more points of a body, wherein the one or more points of the body comprise at least one of a head, a hand, and a foot; and removing an outlier from a set of image segmentations identifying the object based on the image segmentations of the one or more points of the body.

In some embodiments, each vertical camera array comprises a rigid body to which each camera of the vertical camera array is secured such that the camera cannot move independently of the rigid body.

In some embodiments, the object tracking system further includes a plurality of modular structural components that, when assembled, secure the vertical camera arrays at a particular elevation above the playing space and at a particular distance from one another.

In some embodiments, the object tracking system further includes an object-launching machine disposed proximate to the first face of the playing space and a screen proximate to the first face and directed towards the playing space, wherein the pair of vertical camera arrays are on either side of the screen, and the screen comprises a digital screen or a projector screen.

In some embodiments, the playing space is at least in part defined by the first face and two walls that form two corners with the first face, and the vertical camera arrays are disposed proximate to the two corners.

In some embodiments, the object is a soccer ball.

Also disclosed herein is an object tracking method, in accordance with some embodiments. The method includes obtaining a set of images from cameras of a pair of vertical camera arrays, wherein the pair of vertical camera arrays is disposed adjacent to a first face of a playing space, each vertical camera array comprises two cameras arranged vertically within the vertical camera array, the cameras of the pair of vertical camera arrays are time-synchronized, and the set of images comprises a first sequence of image pairs captured at successive times by the cameras of one of the vertical camera arrays, and a second sequence of image pairs captured at the successive times by the cameras of the other vertical camera array. The method further includes identifying an object in the set of images based on object recognition processing. The method further includes determining whether the object is disposed in a first portion of the playing space or in a second portion of the playing space, wherein the playing space comprises a floor surface area proximate to the first face, and the first portion and the second portion divide the floor surface area along a midline perpendicular to a midpoint of the first face. The method further includes selecting either the first sequence of image pairs or the second sequence of image pairs based on the determination of whether the object is disposed in the first portion of the playing space or the second portion of the playing space. The method further includes tracking a location of the object within the playing space over time using the selected sequence of image pairs, wherein the tracking comprises triangulating the location of the object at one of the successive times.

In some embodiments, each vertical camera array additionally comprises a third camera vertically positioned between the two cameras of the vertical camera array, and the method further includes obtaining a second set of images from the third cameras of the vertical camera arrays, the second set of images comprising replay image pairs captured at the successive times by the third cameras, stitching at least some of the replay image pairs together, resulting in a set of panoramic replay images, and displaying the set of panoramic replay images as a video on a screen of the object tracking system.

In some embodiments, each of the cameras of each vertical camera array is disposed such that a wider dimension of an aspect ratio of the camera is vertical, and each of the cameras of each vertical camera array includes in a respective field of view at least part of a floor surface area of the playing space and at least part of a ceiling surface area of the playing space.

In some embodiments, the object recognition processing comprises applying the set of images to an artificial intelligence (AI) classifier model trained on historic images taken by the cameras of the vertical camera arrays, resulting in an image segmentation of the object within at least some images of the set of images.

In some embodiments, triangulating the location of the object at one of the successive times includes applying a particular image pair, from the selected sequence of image pairs, that corresponds to the one of the successive times, to an artificial intelligence (AI) classifier model, resulting in image segmentations of the object and one or more points of a body, wherein the one or more points of the body comprise at least one of a head, a hand, and a foot; and removing an outlier from a set of image segmentations identifying the object based on the image segmentations of the one or more points of the body.

In some embodiments, the pair of vertical camera arrays includes a first vertical camera array and a second vertical camera array, the first vertical camera array is disposed adjacent to the first face of the playing space on a side of the midline corresponding to the first portion of the playing space, the second vertical camera array is disposed adjacent to the first face of the playing space on a side of the midline corresponding to the second portion of the playing space, the first sequence of image pairs are captured by the first vertical camera array and include images of the second portion of the playing space, and the second sequence of image pairs are captured by the second vertical camera array and include images of the first portion of the playing space.

In some embodiments, each vertical camera array comprises a rigid body to which each camera of the vertical camera array is secured such that the camera cannot move independently of the rigid body.

These and other features of the concepts provided herein will become more apparent to those of skill in the art in view of the accompanying drawings and following description, which describe particular embodiments of such concepts in greater detail.

### BRIEF DESCRIPTION OF THE DRAWINGS

Embodiments of the disclosure are illustrated by way of example and not by way of limitation in the figures of the accompanying drawings, in which like references indicate similar elements and in which:

FIG. 1A illustrates an object tracking studio, in accordance with some embodiments.

FIG. 1B illustrates a more detailed schematic of an object launching portion of the object tracking studio, in accordance with some embodiments.

FIG. 2 illustrates a previous model of an object tracking studio, in accordance with some embodiments.

FIG. 3 illustrates a more detailed schematic of vertical camera arrays upon a face of the object tracking studio, in accordance with some embodiments.

FIGS. 4A-4C are top-down views of the object tracking studio illustrating a cross section of the fields of view of cameras of vertical camera arrays, in accordance with some embodiments.

FIGS. 5A-5C are top-down views of the object tracking studio illustrating a cross section of the fields of view of cameras of vertical camera arrays, in accordance with some embodiments.

FIG. 6 is a data flow diagram illustrating image sequences from vertical camera arrays, in accordance with some embodiments.

FIG. 7 illustrates a computing environment including an object tracking studio, in accordance with some embodiments.

FIG. 8A is a block diagram illustrating logical components of a computing device, in accordance with some embodiments.

FIG. 8B is a block diagram illustrating logical components of an object tracking logic, in accordance with some embodiments.

FIGS. 9A-9B are together a flowchart illustrating a method of tracking an object in the object tracking studio, in accordance with some embodiments.

FIG. 10 is a flowchart illustrating a method of rejecting outliers in an object tracking technique, in accordance with some embodiments.

FIG. 11 is a flowchart illustrating a method of generating a replay video, in accordance with some embodiments.

FIG. 12 is a flowchart illustrating a method of user experience in the object tracking studio, in accordance with some embodiments.

FIG. 13A illustrates a second object tracking studio, in accordance with some embodiments.

FIG. 13B illustrates a third object tracking studio, in accordance with some embodiments.

FIGS. 14A-14C are top-down views of the object tracking studios in either of FIGS. 13A-13B illustrating a cross section of the fields of view of cameras of vertical camera arrays, in accordance with some embodiments.

FIGS. 15A-15C are top-down views of the object tracking studio in either of FIGS. 13A-13B illustrating a cross section of the fields of view of cameras of vertical camera arrays, in accordance with some embodiments.

FIG. 16 is a top-down view of the object tracking studio in either of FIGS. 13A-13B illustrating a cross section of the fields of view of cameras of vertical camera arrays as shown in FIG. 5C, in accordance with some embodiments.

FIGS. 17A-17C are illustrations of example configurations of camera array pairs, in accordance with some embodiments.

### DETAILED DESCRIPTION

Various embodiments of the disclosure relate to an object tracking system that improves object tracking within a defined space and generating graphical visualizations based on data obtained or determined as a result of the object tracking. In some particular embodiments, the object tracking system includes a plurality of vertical camera arrays that capture a series of images of a playing space within an object tracking studio following the launch of an object. The object tracking system further includes logic that receives the captured images and performs object recognition analyses to detect the object within images and track the object as it moves through the playing space.

More particularly, the vertical camera arrays may be disposed on either side of a face, such as a wall that defines a boundary of the playing space. The vertical camera arrays may be in a mirrored configuration such that each vertical camera array is positioned at an equal height and are equidistant from a midpoint of the wall, and may be equally tilted inwards towards a midline of the playing space. The orientation of the cameras may be such that each side of the playing space, e.g., either side of the midline, is largely within the field of view of cameras of a vertical camera array on the opposite side of the midline, from a floor surface area to a ceiling. Additionally, the cameras of the vertical camera arrays are time-synchronized such that each camera captures an image simultaneously (e.g., within a 40-nanosecond range) such that the object is located at effectively the same point in the playing space in each image. The set of captured images for a given time is analyzed by logic of the object tracking system to detect the object and triangulate the object's position within the defined space using captured images from one of the vertical camera arrays.

As will be discussed in further detail below, the camera configuration described above solves the problem of failing to capture two images where both images contain a moving object to be tracked at the same location and where both images are not affected by occlusion from the moving object, i.e., the object being within a close proximity to the camera lens such as substantially 1-1.5 meters. The need for two such images stems from the use of triangulation to determine the object's location within the defined space. The particular configuration and techniques described herein involving vertical camera arrays disposed proximate to a face bounding the playing space improves upon prior object tracking systems by reducing the complexity of the tracking operations, requiring fewer components, less power, and less computing time. Furthermore, various embodiments of the object tracking studio provide for improved modularity and portability, enabling greater flexibility with respect to deployment of the object tracking studio. For example, in some embodiments, the components comprising the object tracking studio can fit within a cargo van and are readily able to be assembled or dissembled, rather than permanently installed.

Further embodiments of the disclosure relate to an analysis of the moving object's determined location over time to determine a particular point on a wall, screen, netting, etc., of the playing space that the object is expected to contact and generating a visual graphic for display based on the determined point. For instance, the object may be traveling through the playing space towards a wall of the playing space and, when the object is determined to be a threshold distance from the wall based on the object tracking, the logic of the object tracking system may perform an analysis to determine a point on the wall that the object is expected to hit. The logic may then cause a graphic visualization to be displayed on the wall based on the determined point, such as a three-dimensional visualization of the ball’s continued movement into a digital playing space representing an outcome of the object’s trajectory were the wall not there. As an alternative embodiment, a netting may be placed in front of an electronic screen (e.g., a television screen, monitor in communication with a computing device, or projector screen upon which a visualization is projected), on which the visual graphic is rendered.

The examples provided in the disclosure are generally based in athletics and may use specific terms relevant to sports (e.g., kick, ball); however, the disclosure is not intended to be limited to such examples. Instead, the such examples are merely intended to provide for an illustrative and clear description of the features of the invention. Further, although American soccer (generally referred to as “football” elsewhere in the world including the United Kingdom for example) is used as the primarily example, the disclosure is not so limited and instead applies to various sports including, but not limited or restricted to, soccer (football), American football, softball, baseball, hockey, tennis, golf, lacrosse, Frisbee, ping pong, rugby and/or basketball. A person of skill in the art will recognize that the systems and techniques described herein apply to embodiments unrelated to sports, such as tracking a bird within an aviary, without departing from the principles set forth herein. The specific examples provided are done so for purposes of clarity and continuity throughout the description and illustrations.

Current camera systems and accompanying computer vision logic are insufficient to fill the particular objectives referenced above. Specifically, no current camera system and accompanying computer vision technology includes a plurality of time-synchronized cameras arranged in vertical camera arrays that capture a series of images such that accompanying computer vision logic may analyze a plurality of images, such that the analyses track the location of an object from the moment it is launched until the time the ball is received by a player, and from the moment the ball is released by the player toward a particular point or area (e.g., a screen, wall, or other designated area such as a physical goal apparatus). It should be understood that the term a “goal scored” (or comparable wording) may refer to a ball contacting a particular a point of a face, such as a screen, where some graphic is displayed on the screen. In other embodiments, the vertical camera arrays and the accompanying computer vision logic disclosed herein may be utilized with traditional soccer goals, e.g., on or adjacent to a goal plane such as integrated into or coupled to each vertical goal post.

In particular, one aspect in which existing camera systems and accompanying computer vision logic fail to meet the above objectives is the inability of such systems and logic to handle the tracking of certain “large” objects at a close range, especially when the object is moving within a defined space. One example of a large object is a soccer ball where close range may refer to 1-1.5 meters from a camera lens. In some instances, the defined space may be 4.5 meters wide, 10 meters long, and approximately 3-3.5 meters in height. However, these measurements are merely intended as one illustration and not intended to be limited in any respect. Various existing camera systems may require excessive numbers of components, amounts of power, quantity of computing resources, or other complexities that are made more efficient through the systems and techniques described herein.

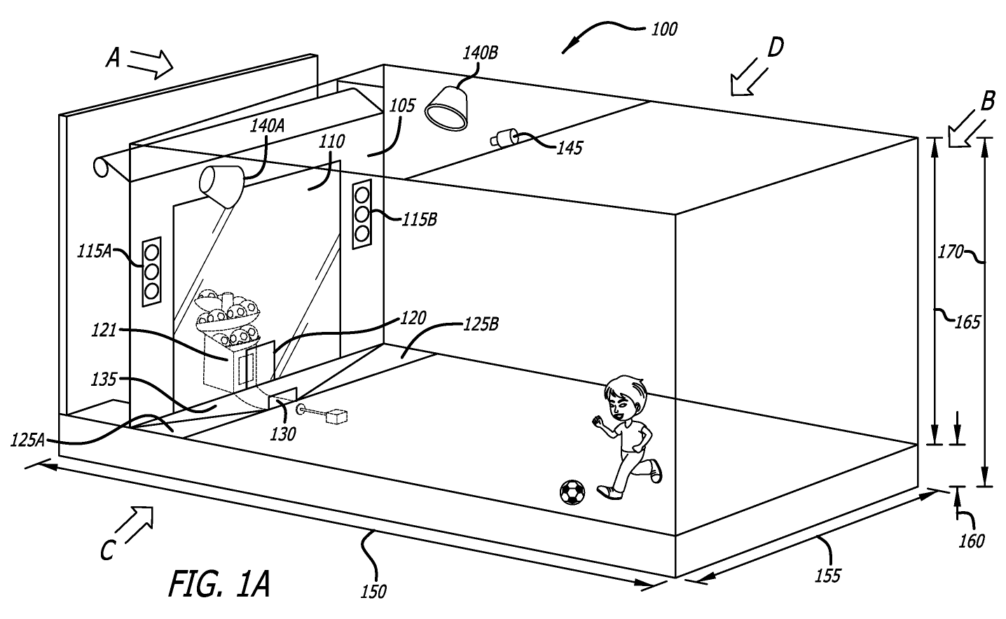

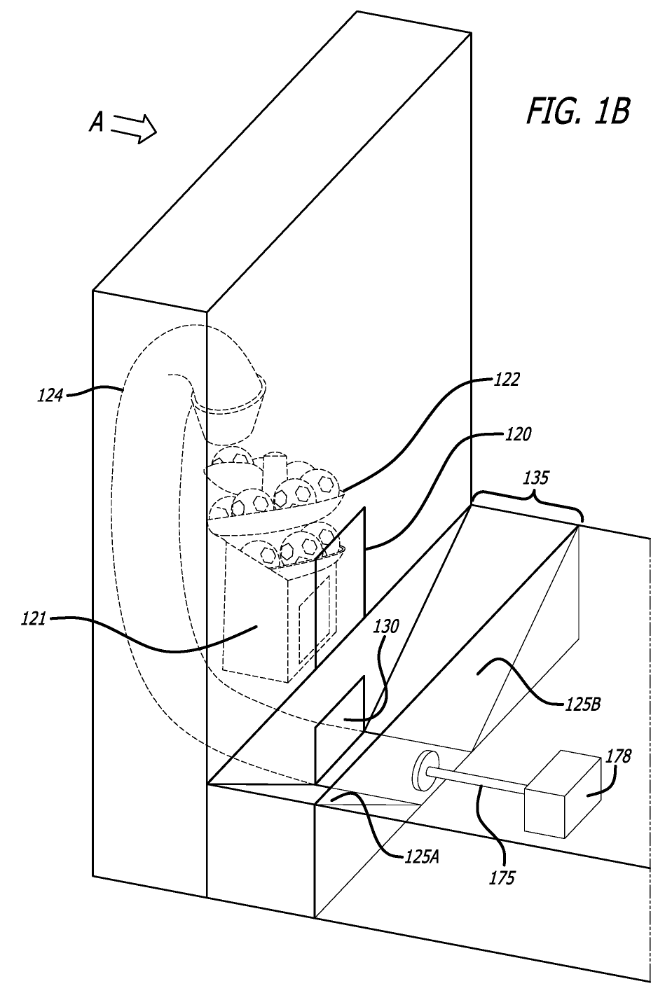

When considering traditional sports arenas or playing fields, there are a number of readily apparent differences from the predefined space discussed herein with one exemplary embodiment illustrated in FIG. 1A that prevent current camera systems and accompanying logic used therewith to meet the particular objectives described above, particularly with the efficiency of the systems and techniques described herein. For example, sports arenas typically include a playing surface (field, court, rink, etc.) surrounded by stadium seating such that any videography equipment may be disposed high above or otherwise at a distance much greater than the playing space discussed herein. As videography equipment of current camera systems is disposed at a much greater distance from the athletic activities (e.g., one or more players interacting with a ball, puck or other object), such camera systems face no issues with occlusion of a camera's field of view by a ball, a player or other objects that from part of the game or gaming environment. Smaller existing gaming environments can require excessive numbers of components, amounts of power, quantity of computing resources, or other complexities that are made more efficient through the systems and techniques described herein.

As one illustrative example, an American football stadium may have several cameras disposed around the stadium positioned to capture images or video of the football game. As the cameras are placed so far from the action, the football does not come close enough to a camera to occlude the view of the camera. Stated otherwise, as the football is so small relative to the field of view of the camera, the camera does not suffer from issues of ball occlusion. Thus, the camera configurations and accompanying logic of current camera systems do not account for possible occlusion of a camera's field of view. Further, such camera systems are not time-synchronized and configured to capture images simultaneously (e.g., within 40 nanoseconds).

The invention disclosed herein addresses new problems that arise when attempting to track an object within a small and/or confined playing surface (an “object tracking studio” or simply “studio”). In particular, the studio configuration can create the problem of an object (e.g., a ball) occluding the view of a camera when the ball came within a close distance of the camera (e.g., substantially 1 meter) such that an image captured by the occluded camera lens is insufficient for use by logic of the object-tracking system to triangulate the location of the ball. In particular, when an image is captured with the ball at such a close distance to the lens of the camera, the logic of the object-tracking system cannot identify features of the studio space due to ball occlusion and therefore cannot use the image to triangulate the location of the ball. Furthermore, as described above, smaller existing gaming environments can require excessive numbers of components, amounts of power, quantity of computing resources, or other complexities that are made more efficient through the systems and techniques described herein. As will be discussed in further detail below, the invention addresses the occlusion problem through a particular configuration of components, including a particular configuration of vertical camera arrays within the studio.

Before some particular embodiments are disclosed in greater detail, it should be understood that the particular embodiments disclosed herein do not limit the scope of the concepts provided herein. It should also be understood that a particular embodiment disclosed herein can have features that can be readily separated from the particular embodiment and optionally combined with or substituted for features of any of a number of other embodiments disclosed herein.

Regarding terms used herein, it should also be understood the terms are for the purpose of describing some particular embodiments, and the terms do not limit the scope of the concepts provided herein. Ordinal numbers (e.g., first, second, third, etc.) are generally used to distinguish or identify different features or steps in a group of features or steps, and do not supply a serial or numerical limitation. For example, “first,” “second,” and “third” features or steps need not necessarily appear in that order, and the particular embodiments including such features or steps need not necessarily be limited to the three features or steps. Labels such as “left,” “right,” “top,” “bottom,” “front,” “back,” and the like are used for convenience and are not intended to imply, for example, any particular fixed location, orientation, or direction. Instead, such labels are used to reflect, for example, relative location, orientation, or directions. Singular forms of “a,” “an,” and “the” include plural references unless the context clearly dictates otherwise.

In certain situations, the terms “logic” and “subsystem” are representative of hardware, firmware, and/or software that is configured to perform one or more functions. As hardware, the logic (or subsystem) may include circuitry having data processing and/or storage functionality. Examples of such circuitry may include, but are not limited or restricted to a processor, a programmable gate array, a microcontroller, an application specific integrated circuit, wireless receiver, transmitter and/or transceiver circuitry, semiconductor memory, or combinatorial logic.

Alternatively, or in combination with hardware circuitry, the logic (or subsystem) may be software in the form of one or more software modules. The software modules may include an executable application, a daemon application, an application programming interface (API), a subroutine, a function, a procedure, an applet, a servlet, a routine, source code, a shared library/dynamic load library, or even one or more instructions. The software module(s) may be stored in any type of a suitable non-transitory storage medium, or transitory storage medium (e.g., electrical, optical, acoustical or other form of propagated signals such as carrier waves, infrared signals, or digital signals). Examples of non-transitory storage medium may include, but are not limited or restricted to a programmable circuit; a semiconductor memory; non-persistent storage such as volatile memory (e.g., any type of random access memory “RAM”); persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the logic (or subsystem) may be stored in persistent storage.

The term “network device” should be generally construed as physical logic (electronics) or virtualized logic with data processing capability and/or a capability of connecting to any type of network, such as a public network (e.g., internet), a private network (e.g., any type of local area network), a public cloud network (e.g., Amazon Web Service (AWS®), Microsoft Azure®, Google Cloud®, etc.), or a private cloud network. Examples of a network device may include, but are not limited or restricted to, any of the following: a server; a mainframe; a firewall; a data transfer device (e.g., intermediary communication device, router, repeater, portable mobile hotspot, etc.); an endpoint device (e.g., a laptop, a smartphone, a tablet, a desktop computer, a netbook, gaming console, etc.); or a virtual device being software that supports data capture, preliminary analysis of meta-information associated with cybersecurity intelligence.

The term “message” generally refers to signaling (wired or wireless) as either information placed in a prescribed format and transmitted in accordance with a suitable delivery protocol or information made accessible through a logical data structure such as an API. Examples of the delivery protocol include, but are not limited or restricted to HTTP (Hypertext Transfer Protocol); HTTPS (HTTP Secure); Simple Mail Transfer Protocol (SMTP); File Transfer Protocol (FTP); iMESSAGE®, Instant Message Access Protocol (IMAP); or the like. Hence, each message may be in the form of one or more packets, frames, or any other series of bits having the prescribed, structured format.

The term “computerized” generally represents that any corresponding operations are conducted by hardware in combination with software and/or firmware.

The term “transmission medium” generally refers to a physical or logical communication link (or path) between two or more network devices. For instance, as a physical communication path, wired and/or wireless interconnects in the form of electrical wiring, optical fiber, cable, bus trace, or a wireless channel using infrared, radio frequency (RF), may be used.

In certain instances, the terms “compare,” comparing,” “comparison,” or other tenses thereof generally mean determining if a match (e.g., identical or a prescribed level of correlation) is achieved between two items where one of the items may include content within meta-information associated with the feature.

Finally, the terms “or” and “and/or” as used herein are to be interpreted as inclusive or meaning any one or any combination. As an example, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure is to be considered as an example of the principles of the invention and not intended to limit the invention to the specific embodiments shown and described.

FIG. 1A illustrates an object tracking studio, in accordance with some embodiments. The object tracking studio (“studio”) 100 includes a playing space, which is a volume defined by boundaries of the studio 100. For example, the playing space can be considered the volume defined by playing space length measurement 150, playing space width measurement 155, and playing space height measurement 165. The studio 100 includes a plurality of cameras utilized to track an object within the playing space. In the embodiment of the figure, the studio 100 includes a pair of vertical camera arrays 115A-115B. As described above, the object-tracking system and methods associated therewith may be used in conjunction with any of several sports including, but not limited or restricted to, soccer (football), American football, softball, baseball, hockey, tennis, golf, lacrosse, Frisbee, ping pong, rugby and/or basketball. The fact that examples and illustrations provided herein are in reference to soccer is not intended to limit the disclosure but is done so for purposes of clarity and continuity throughout the description and illustrations. In various embodiments, the object tracking system comprises some or all components of the studio 100.

The studio 100 is configured for a human (e.g., a player) to receive an object (e.g., a ball) from an object launcher via an object launcher opening 120 in a first face 105 of the studio 100, e.g., a wall, and return the object in the direction of the first face 105. The object launcher is described in further detail with reference to FIG. 1B below and may otherwise be referred to as a “ball-throwing machine” or object-throwing machine” in various embodiments. It is noted that one or more players may participate; however, a single player is described for the sake of clarity. In the illustrative embodiment shown, the studio 100 comprises a rectangular-shaped studio space, where sides of the studio 100 are labeled as A-D (e.g., the first face 105 is on side A of the studio 100). In other embodiments, the studio 100 may have other shapes, such as a trapezoidal shape where side B, opposite the first face 105, has several faces.

In various embodiments, towards side A, the first face 105 is proximate to the object launcher and its opening 120, a screen 110, a gutter 135, a gutter opening 130, two ramps 125A-125B, and the vertical camera arrays 115A-115B. The screen 110, the object launcher opening 120, the gutter opening 130, and the vertical camera arrays 115A-115B may be disposed on the first face 105. The gutter 135 may be directly in front of the first face 105, e.g., towards side B, and include within its volume the ramps 125A-125B and gutter opening 130. As described further below with respect to FIG. 1B, the gutter 135 collects objects, such as balls kicked at the first face 105, which roll down the first ramp 125A or second ramp 125B and enter the gutter opening 130, from which the objects are conveyed to the object launcher for further use. In various embodiments, the studio 110 is constructed of modular structural components that, when assembled, secure one or more components, such as the vertical camera arrays 115A-115B, at a particular elevation above the playing space and at a particular distance from one another (e.g., at particular locations on the first face 105). It should further be understood that the gutter opening 130 and the ramps 125A, 125B included therein may be optional. For example, in embodiments in which the gutter opening and ramps 125A, 125B are not present, the balls may merely hit the first face 105 and fall to the playing surface (ground). The screen 110 may serve to absorb momentum of an object (a ball) and cause the object to fall to the ground in front of the screen 110. In such examples, a round of objects may be thrown from a ball throwing machine with the balls being collected and placed back in a hopper of the ball throwing machine following the round of objects.

An opening may be located at side B, which may allow the player to enter the playing space. In some embodiments, a wall having a door or entrance way may comprise side B of the studio 100. In some embodiments, one or more external surfaces of the studio 100, such as side B or the ceiling, may include a mesh or netting. Further, a projector 145 may be disposed above the playing space, e.g., affixed at a position at or just below the ceiling and approximately above a center point of the playing space. Alternatively, the projector 145 may be disposed at side B (i.e., affixed to an upper portion of a wall or the ceiling), but in preferable embodiments the projector 145 is closer to side A, e.g., above the center point of the playing space. In such preferable embodiments, the projector 145 can be less energy-intensive than a projector 145 positioned at side B, due to its closer proximity to the screen 110, and as such provides energy savings.

Regardless, the projector 145 is configured to project an image onto the screen 110. However, in other embodiments, the projector 145 may be located distal the screen 110 on side A relative to side B (e.g., located behind the screen 110 relative to the playing space) and project onto the screen from behind. In such embodiments, the first face 105 may include a frontmost wall (e.g., a wall furthest in the direction of side A) and a second wall closer to side B. The projector 145 and object launcher may be situated between the frontmost wall and second wall, and the vertical camera arrays 115A-115B, object launcher opening 120, gutter opening 130, and screen 110 may be situated at the second wall (e.g., the screen 110 and vertical camera arrays 115A-115B may be disposed upon the second wall, and the object launcher opening 120 and gutter opening 130 may pass through the second wall). In some embodiments, the projector 145 may project an image on any of the walls of the studio 100. It should be understood that the projector 145 may be positioned elsewhere within the studio environment without departing from the principles set forth herein. It also should be understood that some embodiments do not include a projector 145, e.g., embodiments where the screen 110 is a digital screen that receives visual input from a computing device of the object tracking system, such as a wall-mounted monitor or television.

As shown, a first vertical camera array 115A and a second vertical camera array 115B include the plurality of cameras utilized in tracking the object. As will be discussed below, embodiments of an object-tracking system include a plurality of cameras and a plurality of logic modules. In particular, the plurality of cameras of the object-tracking system are configured to capture images of an object launched by an object launcher and the accompanying logic may perform analyses of the captured images to track the object as it travels to the player and/or is returned toward the screen 110 (e.g., as the player kicks the ball toward the screen). Although the exemplary embodiment of the figures herein illustrates that each vertical camera array 115A-115B includes three cameras, the disclosure is not limited to this number. The object-tracking system may include as few as four cameras, e.g., two cameras per vertical camera array, or may include more than six cameras, in various embodiments.

The studio 100 also may include light sources 140A-140B. A first light source 140A may be affixed proximate to side C of the studio 100 and a second light source 140B may be affixed proximate to side D of the studio 100 in a mirrored configuration across from the first light source 140A. Further, in various embodiments, the light sources 140A-140B are positioned closer to side A than to side B, e.g., between the first face 105 and the projector 145 at the midpoint of the playing space, with respect to the axis which runs side A to side B. In this manner, suitable light for the logical operations performed by the object tracking system is provided within the studio 100 without unnecessary additional light fixtures, which can save energy (e.g., electricity) compared to other implementations. Generally speaking, improved lighting reduces the margin of error of the object tracking system, and improved lighting may only be necessary for some aspects of the logic executed by the object tracking system, in various embodiments. For example, existing training spaces may unnecessarily employ more than two light sources. This can be unnecessary because significant lighting may only be necessary closer to side A, where more precise object tracking may be performed, rather than closer to side B, where interactions between the player and the object can be analyzed by the object tracking system with a higher margin of error. In various non-preferred embodiments, the studio 100 can include more than two light sources 140A-140B.

In various embodiments, the studio 100 can include fewer, other, or additional components than those illustrated. For example, various components described with reference to FIGS. 1B, 3 and 7 may be part of the studio 100, depending on the embodiment. Other components not illustrated for the sake of clarity may be included in the studio 100 as well without departing from the principles set forth herein, such as flooring (e.g., artificial grass disposed upon the floor surface area of the playing space), walls (e.g., nets or sheets of fabric), and a ceiling (e.g., a metal surface or a net). As another example, the studio 100 may include a power source, such as a solar array or a generator.

The logic of the object-tracking system, described in further detail below, may execute various logics, such as an object tracking logic, and may further execute a ballistic trajectory equation using parameters obtained through tracking the object to determine a point on the screen 110 at which the object will, or is expected, to contact. The logic may further generate and transmit instructions to the projector 145 to display a graphic, visualization, etc., on the screen 110 based on the determined point. The instructions may be transmitted via a wired and/or wireless connection from a computing device to the projector 145 (or screen 110 itself, in some embodiments). As is illustrated discussed more below, the logic may include a plurality of logic modules that are stored on non-transitory, computer-readable medium of a computing device, which may be located within a local computer or remotely, e.g., stored and processed within a cloud computing environment.

As one example of use of the studio 100, a player may be participating in a virtual game comprising a virtual goalie and goal displayed on the screen 110 by the projector 145 such that the player is to receive a ball from the object launcher and kick the ball at the screen 110 attempting to place the ball such that the ball contacts the screen 110 in a position resulting in a “goal,” i.e., the ball is to contact the screen at a location within virtual goal posts displayed on the screen other than where the goalie is positioned. In such an embodiment, the plurality of cameras and logic of the object-tracking system may, collectively, capture a plurality of images of the playing space and analyze the captured images to identify the location of the ball as it travels toward the player, as the player interacts with the ball, and as the ball travels away from the player and toward the screen 110. The logic may further determine an expected contact point on the screen 110 (e.g., coordinates of the screen 110, or “screen coordinates”) and generate instructions causing the projector 145 to display a visual on the screen 110, e.g., providing a virtual display of a ball passing by the goalie or a ball being blocked by the goalie.

In further detail, the object-tracking system includes a specific configuration of cameras to capture images of the playing space following the launch of a ball. The cameras are positioned in a mirrored configuration within vertical camera arrays such that the cameras of each vertical camera array are at mirrored positions relative to a center axis (e.g., the midline of the playing space) that runs from side A to side B. In other words, respective cameras of each vertical camera array are located an equal distance away from the screen 110 towards opposing sides of the studio environment, e.g., sides C and D. Additionally, the cameras of the object-tracking system are time-synchronized such that each camera captures an image at the same time. As will be discussed, time-synchronization enables the accompanying logic to triangulate the position of the object using an image pair (i.e., two images captured from two separate cameras at the same time).

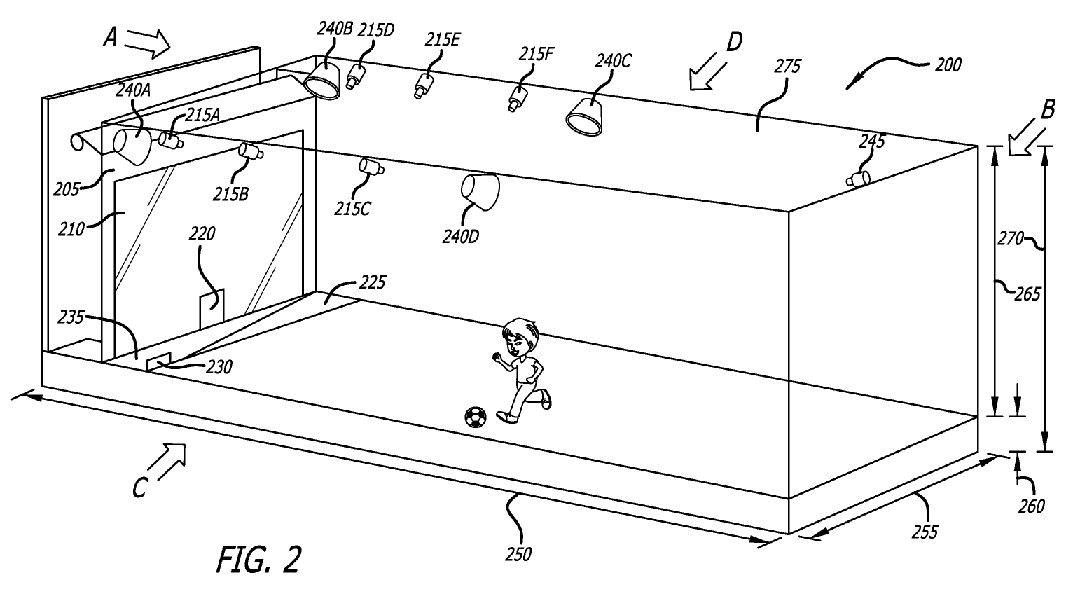

As mentioned above, FIG. 1A visualizes a playing space length measurement 150, a playing space width measurement 155, and a playing space height measurement 165 that can define the volume of the playing space. The playing space height measurement 165, in combination with a subfloor height measurement 160, forms a total height measurement 170 of the studio 100. The subfloor height measurement 160 indicates a height of a subfloor space from the ground to the floor surface area of the playing space. Various components of the studio 100 can be situated in the subfloor space, depending upon the embodiment, such as the gutter 135. As described with further detail below with reference to FIG. 2, differences in these measurements compared to those of existing training spaces can provide beneficial improvements, such as increasing the portability of the studio space, and providing savings on material (such as quantities of metal, wood, or plastic of which studio 100 components are constructed).

FIG. 1B illustrates a more detailed schematic of an object launching portion of the object tracking studio, in accordance with some embodiments. The object launching portion of the object tracking studio, generally, can include the first face 105, the gutter 135, and aspects of the studio 100 proximate to the first face 105 and gutter 135. In various embodiments, when an object enters the gutter 135, it rolls down one of the ramps 125A-125B in the gutter 135 to the gutter opening 130, e.g., a space in the gutter 135 in front of the gutter opening 130. Disposed before the space in front of the gutter opening 130, e.g., towards side B, are a plunger 175 and actuator 178, which are positioned such that actuation of the actuator 178 plunges the plunger 175 into the space in front of the gutter opening 130, thereby pushing the object into the gutter opening 130. In other embodiments, the studio 100 does not include a plunger 175 and/or actuator 178, e.g., in embodiments where the space in front of the gutter opening 130 is sloped towards the gutter opening 130 such that objects roll into the gutter opening 130 without the application of external mechanical force.

Once through the gutter opening 130, the object enters an object feeder 124 that conveys objects from the gutter opening 130 to a hopper 122. In various embodiments, the object feeder 124 is a C-shaped tube. The studio 100 may include multiple objects, and various of the multiple objects can be stored in the object feeder 124 (e.g., having been pushed into the object feeder 124 by the plunger 175). In some embodiments, the object feeder 124 includes one or more flexible check valves or other components to enable objects to travel unidirectionally within the object feeder 124, e.g., from the gutter opening 130 to the hopper 122. In various embodiments, when an object enters the object feeder 124, the object feeder 124 releases a different object into the hopper 122. For example, the object feeder 124 may be full of objects, and when a new object is pushed into the object feeder 124, an object in the object feeder 124 closest to an aperture of the object feeder 124 above the hopper 122 is pushed through the aperture such that the object enters the hopper 122. Other embodiments may employ other or additional object feeders 124, such as conveyor belts.

The hopper 122 is a physical component used to guide objects into a particular position relative to the object launcher 121, such as a loading point of the object launcher 121. In some embodiments, the hopper 122 is part of the object launcher 121, or the studio 100 does not include a hopper 122 and instead the object feeder 124 feeds directly into the object launcher 120. The object launcher 121 is a device that includes a mechanism to launch an object, such as a spring-loaded firing mechanism that launches an object via a spring, or a spinning wheel firing mechanism that launches an object by placing it in contact with one or more spinning wheels. The object launcher 121 launches the object through the object launcher opening 120 into the playing space.

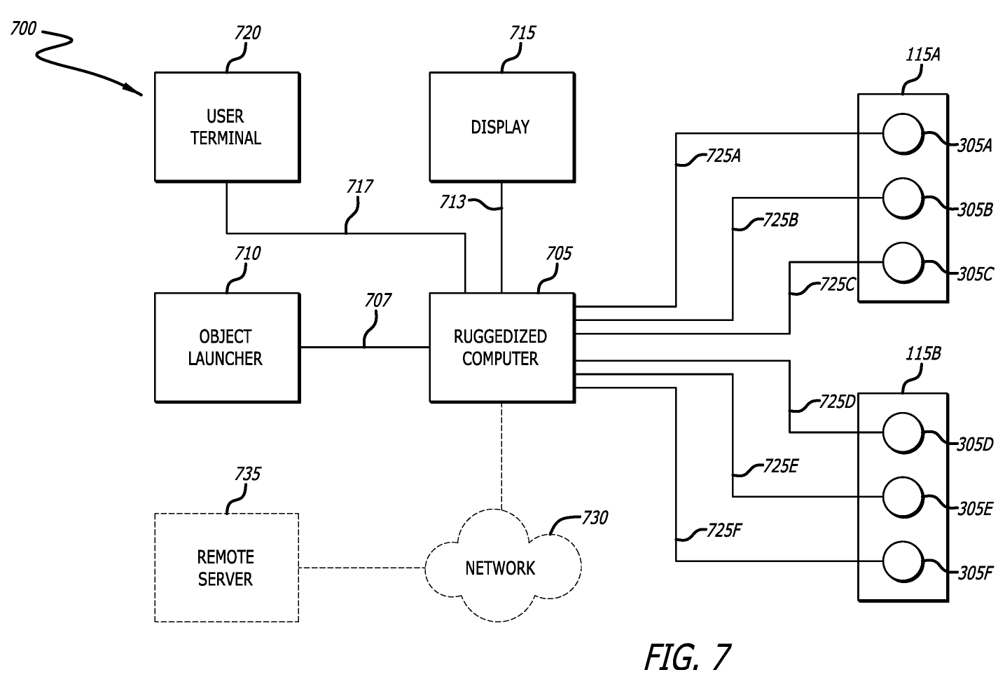

As described in greater detail with respect to FIG. 7, various components related to object launching, such as the actuator 178 and object launcher 121, may be communicatively coupled to a computing device of the studio 100. Logic executed by the computing device sends instructions to the actuator 178 and/or object launcher 121, such as instructions to plunge an object into the gutter opening 130, or to launch an object 121 through the object launcher opening 120 (e.g., with a particular velocity and/or spin). In some embodiments, the actuator 178 is not controlled by the computing device, and instead periodically plunges into the space in front of the gutter opening 130, and/or includes a sensor that detects when an object enters the space in front of the gutter opening 130. Upon detection by the sensor of the object entering the space in front of the gutter opening, the actuator 178 thrusts the plunger 175 into the space in front of the gutter opening 130.

FIG. 2 illustrates a previous model of an object tracking studio, in accordance with some embodiments. The previous model 200 includes a first face 205, such as a wall, towards side A, and forming a boundary of the playing space. The first face 205 has disposed thereon a screen 210 and includes an object launcher opening 220 and gutter opening 230 within a gutter 235 disposed adjacent to the first face 205 closer to side B. The gutter 235 includes a ramp 225 and the gutter opening 230. Unlike the studio 100, the gutter 235 of the previous model 200 includes a longer ramp 235, which is taller than either ramp 125A-125B. As such, a subfloor height measurement 260 of the previous model 200 is greater than the subfloor height measurement 160 of the studio 100. The studio 100 improves upon the previous model 200 with respect to the gutter by including shorter ramps, allowing for a shorter subfloor area, resulting in a more compact studio 100 that is therefore more portable and requires fewer resources to construct. For example, the subfloor height measurement 160 of the studio 100 may be approximately 20% less than the subfloor height measurement 260 of the previous model 200.

The previous model 200 includes six cameras 215A-215F disposed along sides C and D of the playing space in a mirrored configuration with three on each side. In performing object tracking, the previous model 200 may identify a pair of cameras from which to source image pairs for object triangulation operations. Selecting the pair of cameras could involve determining, for each image pair produced among the cameras 215A-215F, a Euclidian distance between a player and an object captured in the images, and selecting as the pair of cameras those cameras corresponding to an image pair with the greatest Euclidian distance. As described in further detail below, object triangulation operations of the studio 100 do not require the Euclidian distance calculations of the previous model 200 to select cameras from which to source images. As such, the object tracking system of the studio 100 beneficially improves the object tracking logic by making that logic more efficient, e.g., requiring fewer operations (and therefore less time and energy to operate as well).

The previous model 200 includes four light sources 240A-D, disposed along sides C and D of the playing space in a mirrored configuration, e.g., two light sources mirrored on either side C and D, close to side A with respect to an axis from side A to side B of the playing space, and two light sources mirrored on either side C and D proximate to a midpoint of the axis running from side A to B. In comparison to the studio 100, the previous model 200 uses twice as many light sources, and therefore consumes greater amounts of power than is needed.

The previous model 200 includes a projector 245 disposed at side B of the playing space, rather than approximately above a midpoint as with the projector 145 of the studio 100. Because the projector 245 is farther from the screen 210 than the projector 145 is distanced from the screen 110, the projector 245 requires greater power consumption to project visual data on the screen 210. As such, the studio 100 includes the beneficial improvement of enabling the use of a projector 145 that requires less power than that of the previous model 200.

The previous model 200 includes a hard-top roof 275. In various embodiments, the previous model 200 required a hard-top roof 275 to enable ballistic trajectory calculations to be performed for an object when the object exited the fields of view of the cameras 215A-215F. These ballistic trajectory calculations were necessary for the previous model 200 to predict a position in the playing space where the object would reenter the fields of view of the cameras 215A-215F. The ballistic trajectory calculations worked only with a hard surface for the object to bounce off, so the previous model 200 required a hard-top roof, such as metal or wood. In comparison, the fields of view of the cameras of the vertical camera arrays 115A-115B include the ceiling of the playing space (also referred to as a “ceiling surface space”), and as such do not need to perform ballistic trajectory calculations with respect to the ceiling. This provides for a reduction in the computations performed by the object tracking system, providing a beneficial improvement to the efficiency of the computing and reducing the energy consumed by executing object tracking logic. Furthermore, in the studio 100, the ceiling can be hard or soft (e.g., a net or mesh). Allowing for soft roofing improves the portability of the studio 100. For example, a roof net is typically much lighter and occupies less volume when dissembled than a solid metal roof of equivalent size.

Another benefit of the studio 100 and its employment of vertical camera arrays 115A-115B is the capability to reduce the size of the playing space without negatively altering the performance of the object tracking logic, as compared to the previous model 200. In various embodiments, a playing space length measurement 250 of the previous model 200, a playing space width measurement 255 of the previous model 200, and a playing space height measurement 265 of the previous model 200 are each up to 20% greater than their equivalents for the studio 100 (and, therefore, the total height measurement 270 of the previous model 200 is likewise up to 20% greater than the total height measurement 170 of the studio 100). In other words, the dimensions of the studio 100 are up to 20% reduced when compared to the dimensions of the previous model 200.

Despite this reduced size, the object tracking logic used in conjunction with the vertical camera arrays 115A-115B is still capable of tracking the object in the playing space, and this reduction in size allows for greater portability of the studio 100. For example, the studio 100 may be built of modular structural components that can be assembled and dissembled. Because the studio 100 is approximately 20% smaller in each dimension than the previous model 200, the modular structural components are respectively smaller than the structural components of the previous model 200 (which was not modular), and therefore occupy less space when dissembled and also weigh less than their equivalents in the previous model 200. Because the modular structural components of the studio 100 are smaller and weigh less, they are more portable in comparison to the previous model 200.

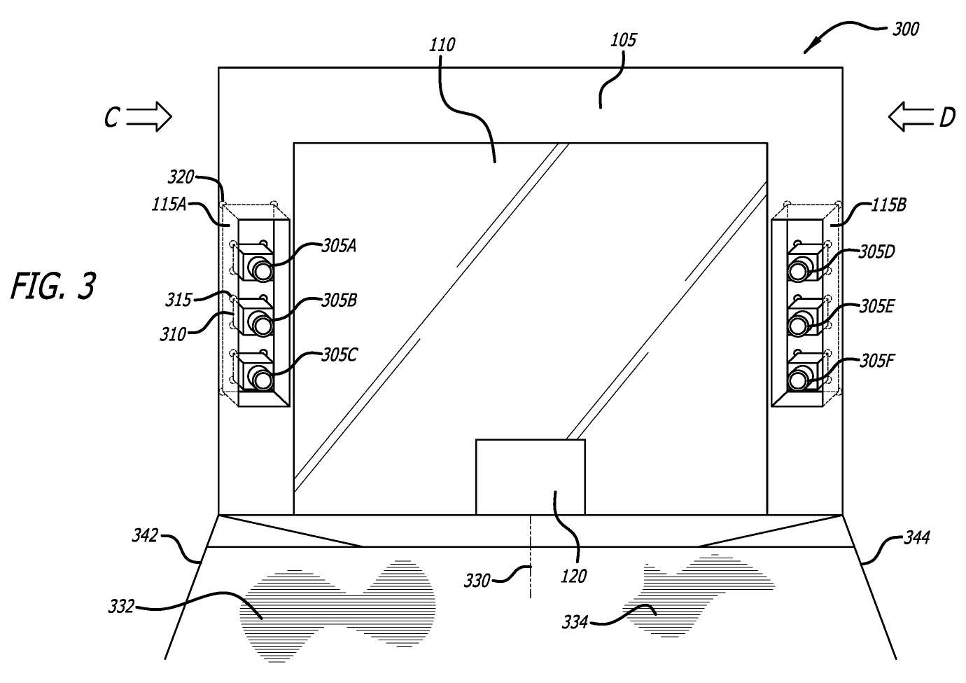

FIG. 3 illustrates a more detailed schematic of vertical camera arrays upon a face of the object tracking studio, in accordance with some embodiments. The example of the figure is from a frontal perspective 300 facing the first face 105 from the center of the playing space, e.g., in line with a midline 330 of the floor surface area of the playing space. The midline 330 divides the floor surface area into two sides, a first portion of playing space closer to side C and a second portion of playing space closer to side D. For example, the first portion is partially bound by the midline 330, the first face 105, and side 342 of the studio 100 (e.g., a side wall at side C), and the second portion is partially bound by the midline 330, the first face 105, and side 344 of the studio 100 (e.g., a side wall at side D). A fourth boundary of the first portion and the second portion may be side B of the playing space, e.g., a wall at side B. Area 332 is within the first portion, and area 334 is within the second portion. The first portion and the second portion may each include a respective half of the volume of the playing space, e.g., extending from the floor surface area to the ceiling of the studio 100.

The example of the figure includes the first vertical camera array 115A and the second vertical camera array 115B disposed on either side of the screen 110 in a mirrored configuration, approximately halfway between the floor surface area and the ceiling of the studio 110, and equidistant along the first face 105 from the midline 330. In various embodiments, the vertical camera arrays 115A-115B include rigid camera housings 310 each housing two or more cameras. In the example of the figure, each vertical camera array 115A-115B includes three cameras. Each camera 305A-305C of vertical camera array 115A is mirrored positionally across the midline 330 with respective cameras 305D-305F of vertical camera array 115B. Cameras 305A, 305C, 305D, and 305F are tracking cameras, e.g., produce images used for object tracking, and cameras 305B and 305E are replay cameras, e.g., produce images used for generating replays, as described in further detail below. In other embodiments, the vertical camera arrays 115A-115B can include fewer or more cameras. In some embodiments, the cameras 305A-305F are each disposed such that a wider dimension of an aspect ratio of the camera is vertical, where the aspect ratio of the camera includes a wider dimension and a perpendicular less-wide dimension.

The rigid camera housing 310 of each vertical camera array 115A-115B is a rigid body constructed of a rigid material, such as metal or hard plastic, and includes one cavity or fixture location for each camera of the vertical camera array. Cameras 305A-305F are fixed within the rigid camera housing 310 of the respective vertical camera array 115A-115B with one camera at each cavity or fixture location. Each camera 305A-305F is fastened to the rigid camera housing 310 by one or more camera fasteners, such as camera fastener 315. Depending on the embodiment, the camera fastener 315 can include one or more of any of a variety of components, such as glue, a screw, a tight-fitting sheath, or so on. The rigid camera housing 310 of each vertical camera array 115A-115B is fastened to the first face 105 by one or more rigid array fasteners, e.g., rigid array fastener 320. Depending on the embodiment, the rigid array fastener 320 can include one or more of any of a variety of components, such as a screw, a fitted slot (where an appendage of the rigid camera housing 310 securely fits into a slot on the first face 105), a clamp, or so on. The camera fasteners secure the cameras 305A-305F in place such that they do not independently move, and the rigid array fasteners secure the rigid camera housings in place such that they do not move independently of the first face 105. In this manner, the object tracking system can use knowledge of the positions of the cameras to inform object tracking logic, and margins of error are reduced by avoiding the movement of cameras from expected locations.

As described in further detail below, each vertical camera array 115A-115B is used to track objects on an opposite side of the playing space. For example, vertical camera array 115A may be used to track objects in the second portion, and vertical camera array 115B may be used to track objects in the first portion. Rather than selecting two cameras to use the images of for triangulation based on various Euclidian distances, as with the previous model 200, the object tracking system of the studio 100 selects one of the vertical camera arrays 115A-115B based on whether the object is detected within the first portion or the second portion of the playing space.

In various embodiments, each vertical camera array 115A-115B is angled slightly towards the midline 330. For example, rather than being disposed in line with the first face 105 such that each camera 305A-305F is directed perpendicularly with respect to the first face 105, each vertical camera array 115A-115B may be tilted a number of degrees towards the midline 330 (e.g., be fixed to the first face 105 with a certain amount of yaw) such that the cameras of vertical camera array 115A capture in their field of view more of the second portion of the playing space, and the cameras of vertical camera array 115B capture in their field of view more of the first portion of the playing space. By increasing the amount of the opposite portion of playing space captured in the field of view of a vertical camera array, the object tracking system of the studio 100 increases the volume within which an object can be tracked, and reduces the amount of volume of playing space through which movement of the object is estimated.

In particular, angling the cameras towards the midline 330 includes more volume of playing space near the first face 105 in the fields of view of the cameras, reducing the distance between the first face 105 and an edge of a field of view proximate to side A of each camera, over which distance movement of the object is estimated by the object tracking system to identify a position upon the first face 105 most likely to be struck by the object. If the distance were greater, e.g., if the cameras were not angled towards the midline, then the margin of error of the estimated position upon the first face 105 to be struck by the object would be greater, and could cause an incorrect graphical visualization to be displayed upon the screen 110, e.g., a graphical visualization indicating the object striking a location on the first face 105 other than an actual location struck by the object. As such, angling the cameras towards the midline improves the accuracy of the object tracking system when estimating a location on the first face 105 that will be struck by an object based on its trajectory.

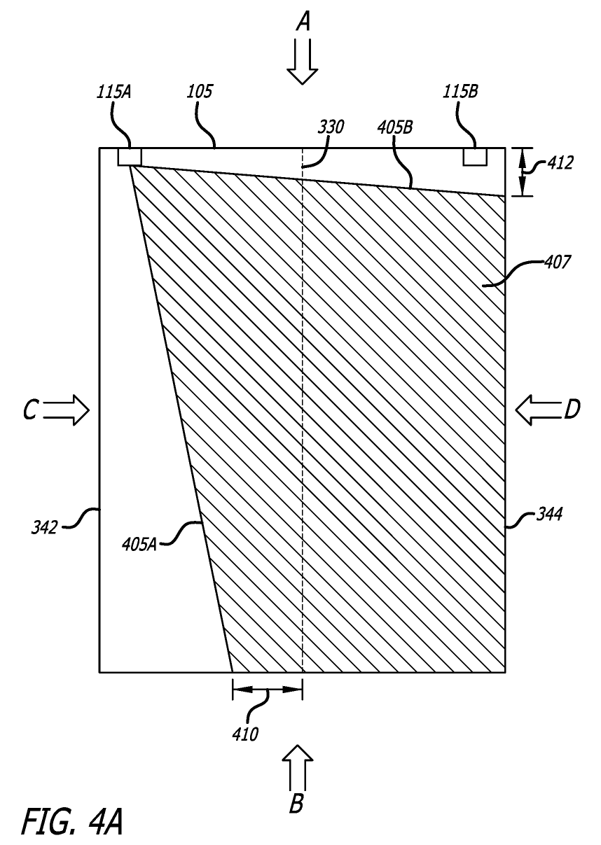

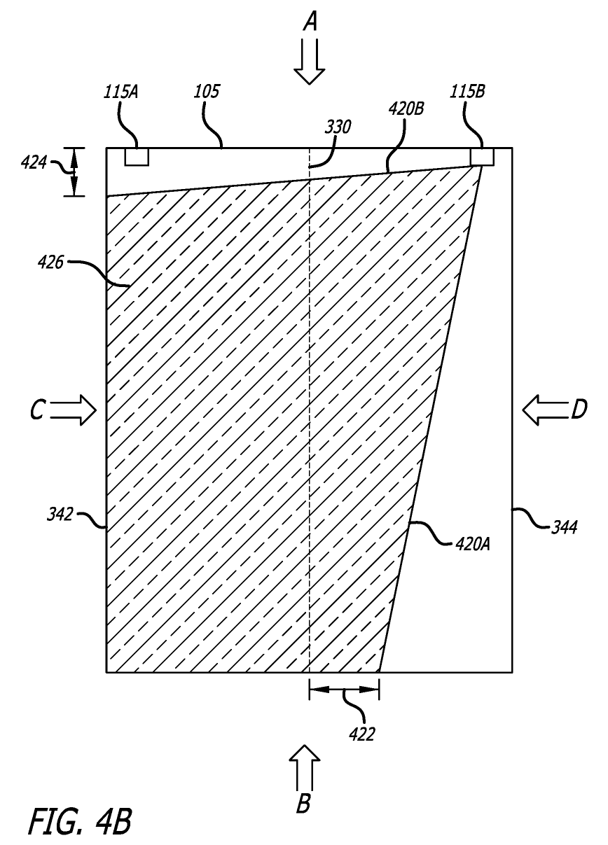

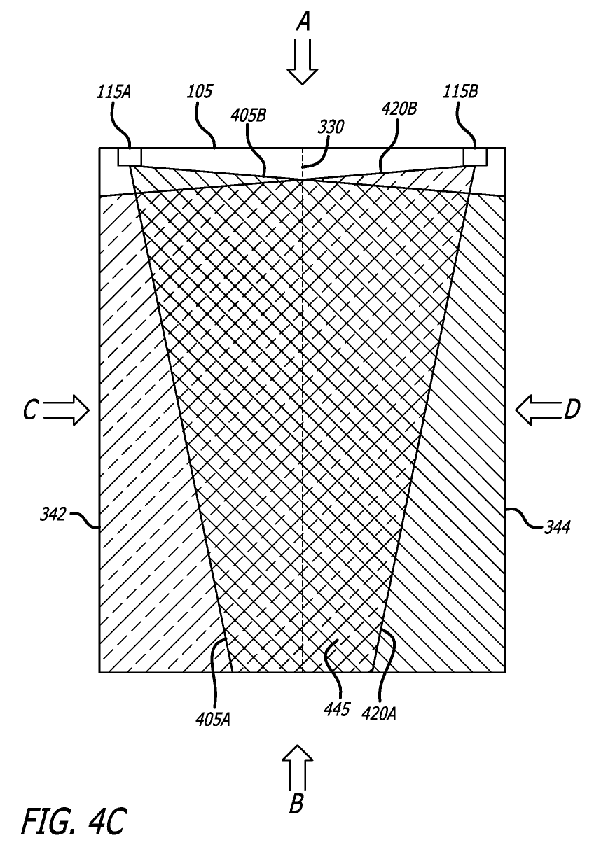

FIGS. 4A-4C are top-down views of the object tracking studio illustrating a cross section of the fields of view of cameras of vertical camera arrays, in accordance with some embodiments. FIG. 4A illustrates a top-down view of the fields of view of cameras of vertical camera array 115A, particularly an area of the floor surface area of the playing space within the fields of view of the cameras of vertical camera array 115A, according to some embodiments. As discussed above, each camera of vertical camera array 115A also includes in its field of view a vertical component from the floor surface area to the ceiling of the studio 100. The area of the floor surface area within the fields of view 407 of the cameras of vertical camera array 115A is shaded in the figure, and is bound by field of view limit (“limit”) 405A and field of view limit 405B. As illustrated, the fields of view 407 are limited 405A a distance 412 from the first face 105. As discussed above, the object tracking system estimates a trajectory of the object from the limit 405A to the first face 105, e.g., over the distance 412. This distance 412 is reduced by angling the vertical camera array 115A towards the midline 330. The fields of view 407 also include part of the first portion of floor surface area, e.g., an area partially defined by limit 405B and the midline 330. The fields of view 407 continue to a point on side B that is distance 410 along side B into the first portion of floor surface area. By capturing some of the first portion of floor surface area in the fields of view 407 of vertical camera array 115A, the object tracking system can, among other operations described further below, generate a panoramic replay video based in part on images captured by cameras of the vertical camera array 115A.

FIG. 4B illustrates a top-down view of the fields of view of cameras of vertical camera array 115B, particularly an area of the floor surface area of the playing space within the fields of view of the cameras of vertical camera array 115B, according to some embodiments. As discussed above, each camera of vertical camera array 115B also includes in its field of view a vertical component from the floor surface area to the ceiling of the studio 100. The area of the floor surface area within the fields of view 426 of the cameras of vertical camera array 115B is shaded in the figure, and is bound by field of view limit 420A and field of view limit 420B. As illustrated, the fields of view 426 are limited 420B a distance 424 from the first face 105. The distance 424 is typically equivalent to distance 412 due to the mirrored configuration of the vertical camera arrays. As discussed above, the object tracking system estimates a trajectory of the object from the limit 420B to the first face 105, e.g., over the distance 424. This distance 424 is reduced by angling the vertical camera array 115B towards the midline 330. The fields of view 426 also include part of the second portion of floor surface area, e.g., an area partially defined by limit 420A and the midline 330. The fields of view 426 continue to a point on side B that is distance 422 alongside B into the second portion of floor surface area. By capturing some of the second portion of floor surface area in the fields of view 426 of vertical camera array 115B, the object tracking system can, among other operations described further below, generate a panoramic replay video based in part on images captured by cameras of the vertical camera array 115B.

FIG. 4C illustrates a top-down view of a cross section of the fields of view of cameras of both vertical camera arrays 115A-115B, according to some embodiments. An overlapping region 445 of floor surface area is captured in images taken by cameras of both vertical camera arrays 115A-115B. As such, objects and/or humans within the overlapping region 445 can be identified in images taken by either of the vertical camera arrays 115A-115B. Between the vertical camera arrays 115A-115B, almost the entirety of the playing space is within the fields of view of the cameras collectively within the studio 100. Only certain regions close to the first face 105 are not captured by at least one of the fields of view. In this manner, objects nearly anywhere in the playing space will be captured by cameras of at least one vertical camera array 115A-115B. For example, an object in the corner of sides C and B will appear in images captured by vertical camera array 115B, and an object in the corner of sides D and B will appear in images captured by vertical camera array 115A. Furthermore, the overlapping region 445 allows the object tracking system to stitch together images from the first vertical camera array 115A and the second vertical camera array 115B to produce panoramic replay images that can form a replay video, as described in further detail below.

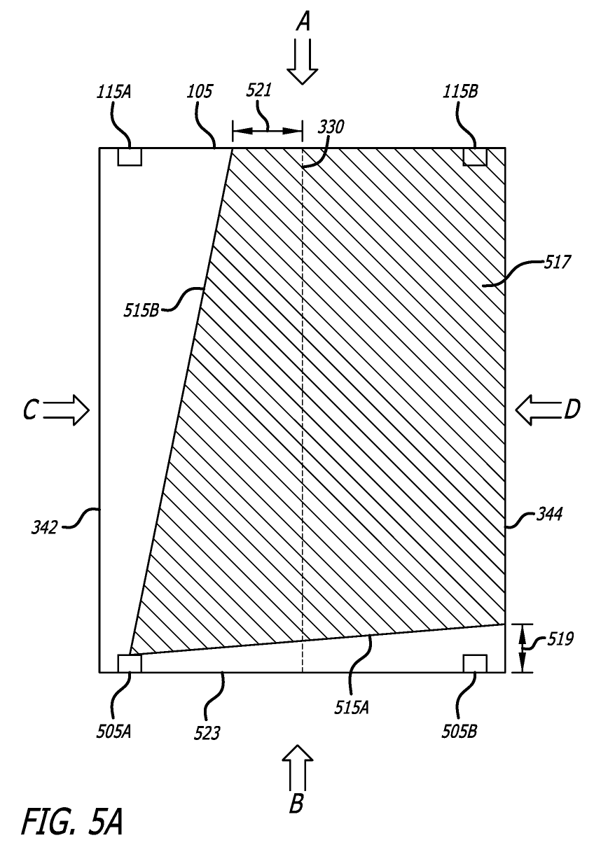

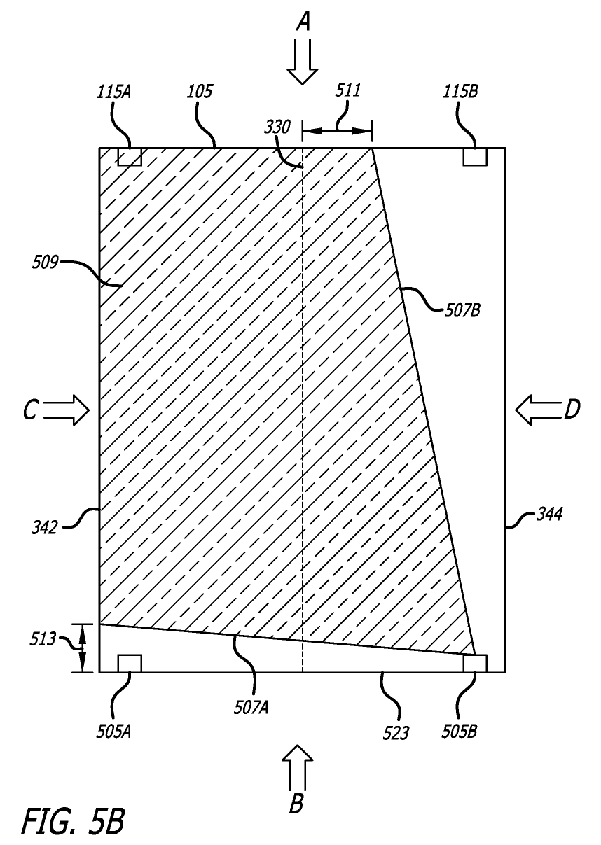

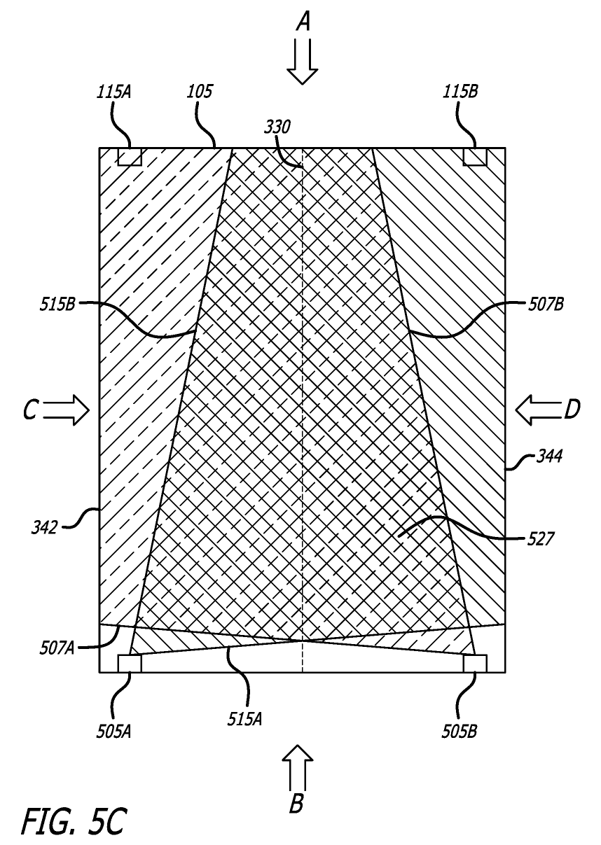

FIGS. 5A-5C are top-down views of the object tracking studio illustrating a cross section of the fields of view of cameras of vertical camera arrays, in accordance with some embodiments. In the examples of FIGS. 5A-5C, the studio 100 additionally includes another pair of vertical camera arrays 505A-505B disposed proximate to side B of the studio 100. In various embodiments, image data from the vertical camera arrays 505A-505B may be used with image data from vertical camera arrays 115A-115B to perform object tracking operations. In particular, image data from vertical camera arrays 505A-505B can be used to improve the accuracy of object tracking operations, such as object segmentation, classification, position estimation, and trajectory estimation. As a particular example, image data from vertical camera arrays 505A-505B can be used to track the object as it reaches the first face 105, avoiding the need for trajectory estimation (e.g., over distance 412 or distance 424).

FIG. 5A illustrates a top-down view of the fields of view of cameras of third vertical camera array 505A, particularly an area of the floor surface area of the playing space within the fields of view of the cameras of vertical camera array 505A, according to some embodiments. Each camera of vertical camera array 505A also includes in its field of view a vertical component from the floor surface area to the ceiling of the studio 100. The area of the floor surface area within the fields of view 517 of the cameras of vertical camera array 505A is shaded in the figure, and is bound by field of view limit 515A and field of view limit 515B. As illustrated, the fields of view 517 are limited 515A a distance 519 from the face 523 of the studio at side B. The fields of view 517 also include part of the first portion of floor surface area, e.g., an area partially defined by limit 515B and the midline 330. The fields of view 517 continue to a point on the first face 105 that is distance 521 along the first face 105 into the first portion of floor surface area. By capturing some of the first portion of floor surface area in the fields of view 517 of vertical camera array 505A, the object tracking system can, among other operations described further below, generate a panoramic replay video based in part on images captured by cameras of the vertical camera array 505A (e.g., a from-the-rear replay video).

FIG. 5B illustrates a top-down view of the fields of view of cameras of vertical camera array 505B, particularly an area of the floor surface area of the playing space within the fields of view of the cameras of vertical camera array 505B, according to some embodiments. Each camera of vertical camera array 505B also includes in its field of view a vertical component from the floor surface area to the ceiling of the studio 100. The area of the floor surface area within the fields of view 509 of the cameras of vertical camera array 505B is shaded in the figure, and is bound by field of view limit 507A and field of view limit 507B. As illustrated, the fields of view 509 are a distance 513 from the face 523 of the studio at side B. The fields of view 509 also include part of the second portion of floor surface area, e.g., an area partially defined by limit 507B and the midline 330. The fields of view 509 continue to a point on side B that is distance 511 along the first face 105 into the second portion of floor surface area. By capturing some of the second portion of floor surface area in the fields of view 509 of vertical camera array 115B, the object tracking system can, among other operations described further below, generate a panoramic replay video based in part on images captured by cameras of the vertical camera array 505B (e.g., a from-the-rear replay video).

FIG. 5C illustrates a top-down view of a cross section of the fields of view of cameras of both vertical camera arrays 505A-B, according to some embodiments. An overlapping region 527 of floor surface area is captured in images taken by cameras of both vertical camera arrays 505A-B. As such, objects and/or humans within the overlapping region 527 can be identified in images taken by either of the vertical camera arrays 505A-B. Between the vertical camera arrays 505A-B, almost the entirety of the playing space is within the fields of view of the cameras collectively within the studio 100, and in combination with vertical camera arrays 115A-115B, the entirety of the playing space is within the fields of view of the cameras of the vertical camera arrays collectively.

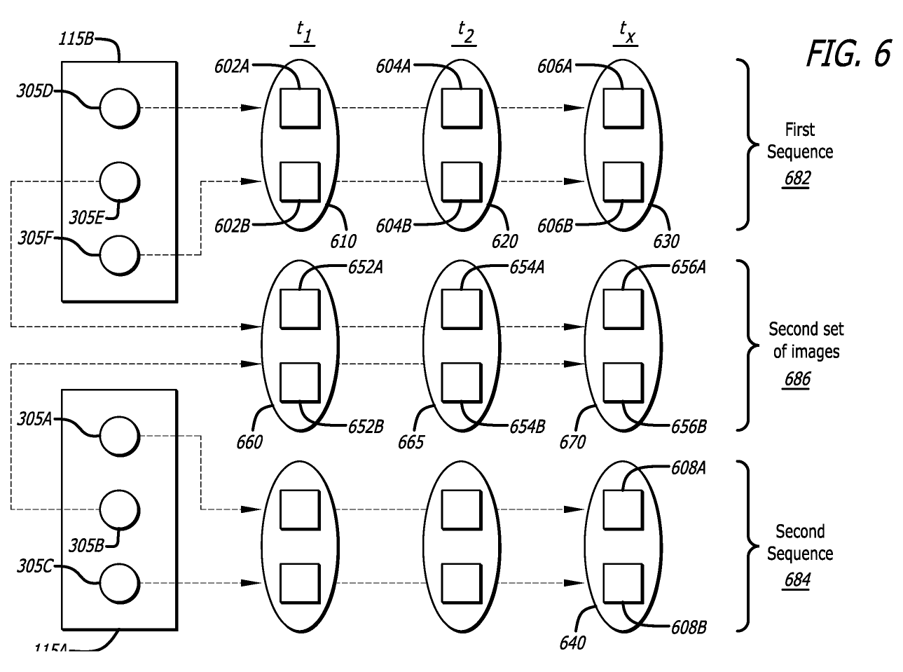

FIG. 6 is a data flow diagram illustrating image sequences from vertical camera arrays, in accordance with some embodiments. In the example of the figure, vertical camera array 115A includes cameras 305A-305C, where camera 305B is a replay camera, and vertical camera array 115B includes cameras 305D-305F, where camera 305E is a replay camera. The six cameras 305A-305F are time-synchronized, and capture images at approximately simultaneous times (e.g., within 40 nanoseconds of one another). Each captured image may be associated with the time at which it was captured, e.g., may be associated with a timestamp (which may be metadata of the image).

The cameras 305A-305F capture images at successive times, such as t₁ and t₂, until time tₓ. For each vertical camera array 115A-115B, images captured by non-replay cameras at a particular time form an image pair. For example, images 602A-602B, captured by camera 305D and camera 305F of vertical camera array 115B respectively at time t₁, form image pair 610. Similarly, at time t₂ images 604A and 604B form image pair 620, and at time tₓ images 606A and 606B form image pair 630. The same is true for vertical camera array 115A. For example, at time tx camera 305A and camera 305C capture images 608A and 608B, respectively, which together form image pair 640. The image pairs produced by a vertical camera array collectively form a sequence. For example, image pairs 610, 620, and 630 captured by cameras of vertical camera array 115B form a first sequence 682, and image pairs captured by cameras of vertical camera array 115A, such as image pair 640, form a second sequence 684. Together, the first sequence 682 and second sequence 684 form a set of images. In various embodiments, this set of images is used for object tracking operations. The images captured by the non-replay cameras of the same vertical camera array, e.g., images captured at the same time by cameras 305A, 305C or by cameras 305D, 305F, may be referenced to as image pairs. Thus, as would follow, a sequence of images captured by non-replay cameras of the same vertical camera array may be referred to as a sequence of image pairs. Additionally, the images captured by the replay cameras of the two vertical camera arrays 115A, 115B (i.e., the cameras 305B, 305E) may be referred to a “replay image pairs.”

Meanwhile, the replay cameras, e.g., camera 305B of vertical camera array 115A and camera 305E of vertical camera array 115B, also capture images at the synchronized times (e.g., t₁, t₂, tₓ). For example, at time t₁, camera 305E captures replay image 652A and camera 305B captures replay image 652B, and images 652A-652B form replay image pair 660; at time t₂, camera 305E captures replay image 654A and camera 305B captures replay image 654B, and images 654A-654B form replay image pair 665; and at time tₓ, camera 305E captures replay image 656A and camera 305B captures replay image 656B, and images 656A-656B form replay image pair 670. The image pairs produced by the replay cameras 305B, 305E collectively form a second set of images 686, e.g., a replay set of images. As described in further detail below, a computing device may use the second set of images 686 to generate a replay video that is displayed on the screen 110. In some embodiments, the vertical camera arrays 115A-115B do not include replay cameras 305B, 305E, and instead the computing device reuses image pairs of the first sequence 682 and/or second sequence 684 to generate the replay video. In some embodiments, the computing device does not generate a replay video.

FIG. 7 illustrates a computing environment including an object tracking studio, in accordance with some embodiments. The computing environment 700 includes a ruggedized computing device 705 (such as a computer), an object launcher 710, a display 715, a user terminal 720, the pair of vertical camera arrays 115A-115B and their cameras 305A-305F, and wires 707, 713, 717, and 725A-725F. In other embodiments, the computing environment 700 includes fewer, additional, or other components than those described herein, and functionality described herein with reference to one component may in other embodiments be performed by a different component, or may not be performed. For example, in some unpreferred embodiments, the computing environment 700 includes a network 730 and remote server 735, and some or all functionality described with reference to the ruggedized computer is instead performed by the remote server 735. As another example, in some unpreferred embodiments, the computing environment 700 does not include some or all wires 707, 713, 717, and 725A-725F, and instead some or all components communicate wirelessly, e.g., over the network 730. As yet another example, in some unpreferred embodiments, the ruggedized computer 705 is instead a non-ruggedized computer.

The ruggedized computer 705 is a computing device designed to survive harsher conditions than a typical computing device (e.g., a personal computer). Typically, the ruggedized computer 705 meets one or more specifications, such as a MIL-STD-810G or MIL-STD-810H military standard, and/or ATEX or C1D2 certification. The ruggedized computer 705 has, depending on the environment, one or more of: increased shock and/or vibration resistance; an impact-resistant casing; sealed ports and/or connectors; a wider than typical operating temperature range, such as between -20 and 60 degrees Celsius; humidity and corrosion resistance; a high ingress protection rating, such as IP65 or greater; sealed keyboards and/or touchscreens; extended battery life; improved power efficiency; a glove-friendly touchscreen; an anti-glare and/or sunlight-readable display; field-serviceable components; and tool-less access panels. In other embodiments, the ruggedized computer 705 can include any other features that protect the ruggedized computer 705 and enable it to operate under conditions not suitable for a typical personal computer.

In various embodiments, the ruggedized computer 705 includes a central processing unit (CPU) and one or more graphics processing units (GPUs). In many embodiments, the ruggedized computer 705 includes a plurality of CPUs and/or GPUs. In some embodiments, the ruggedized computer 705 includes an NVIDIA JETSON ORIN computing device. The ruggedized computer 705 also includes a non-transitory computer-readable storage medium, such as a hard drive, solid state drive, or other computer storage option. The non-transitory computer-readable storage medium stores various logic, such as object tracking logic, as described in further detail below. In various embodiments, the ruggedized computer 705 also stores various data, such as session data, image data, and/or one or more artificial intelligence (AI) models. In some embodiments, the ruggedized computer 705 processes data, such as executing object tracking logic on image data, using a plurality of GPUs included in the ruggedized computer 705, and executes session logic, such as running a game server, using one or more CPUs of the ruggedized computer 705. In this manner, the ruggedized computer 705 can provide various processing capabilities employed in the studio 100 simultaneously.

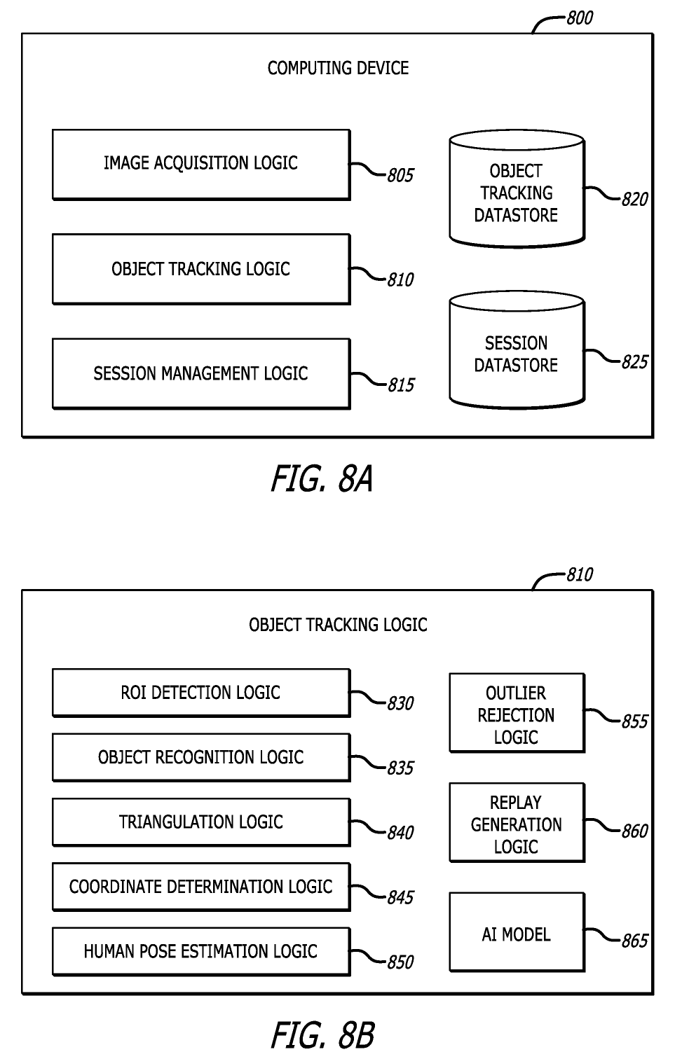

The ruggedized computer 705 executes logic of the object tracking system of the studio 100, such as image acquisition logic, object tracking logic, and session management logic (as described with reference to FIG. 8).The ruggedized computer 705 receives image data from the cameras 305A-305F via respective wires 725A-725F. The ruggedized computer 705 sends instructions to other components of the computing environment 700, such as camera calibration or image acquisition instructions to the cameras 305A-305F, object launching instructions to the object launcher 710, and/or session graphical visualization or video replay instructions to the display 715. Various operations and functionality of the ruggedized computer 705, according to various embodiments, are described below with reference to FIGS. 8-12.

The object launcher 710 can include the object launcher 121 and in some embodiments the actuator 178 and/or hopper 122. The object launcher 710 can also include a processor to execute object launcher control logic based on instructions received from the ruggedized computer 705. For example, based on various instructions received from the ruggedized computer 705, the object launcher 710 can actuate the actuator 178, release an object from the hopper 122 into the object launcher 121, and/or launch an object into the playing space. The instructions can include a particular velocity and/or spin to apply to the object at launch, in various embodiments.

The display 715 can include the screen 110, e.g., in embodiments where the screen 110 is a digital display such as a monitor or television, or can include the projector 145, e.g., in embodiments where the screen 110 is a projector screen upon which visual data is projected by a projector. In some embodiments, the studio 100 includes more than one screen 110, such as embodiments that include a digital display and a projector and projector screen, where some data, such as session metrics, are displayed on the digital display, and other data, such as a replay video, is displayed on the projector screen. In such embodiments, the display 145 generally refers to the multiple screens 110. The display 715 receives data, such as image data, from the ruggedized computer 705, such as an object trajectory graphic, a replay video, or session metrics, and displays the received data. For example, the display 715 may present some or all of the data on a digital display when the display 715 includes a digital display, and/or may project some or all of the data via the projector 145 onto screen 110 when the display 715 includes a projector 145. In some embodiments, the projector screen that a projector 145 projects upon is the first face 105 itself, e.g., a surface area of a wall at side A.

The user terminal 720 is a computing device which, in conjunction with the ruggedized computer 705, initiates and/or manages some or all user-related operations in the studio 100. In some embodiments, some or all of a session management logic and/or a session data store is local to the user terminal 720, which is communicatively coupled to the ruggedized computer 705. For example, in some embodiments, the user terminal 720 includes session management logic and the ruggedized computer 705 also includes session management logic as well as the session data store. In various embodiments, the user terminal 720 includes a personal computer, such as a desktop or laptop; a kiosk, such as a digital kiosk that includes a touchscreen display and a computing device; a portable computing device, such as a tablet or smartphone. In some embodiments, the user terminal 720 is a personal computing device of the player, such as a smartphone of the player, which communicates with the ruggedized computer 705 via an application programming interface (API). For example, a web application that implements an API associated with the studio 100 and exposes functionality to the player via a web page accessible by a browser, or a dedicated application on the player’s personal computing device. In some embodiments, the ruggedized computer 705 comprises the user terminal 720.

Users, such as players using the studio 100 to conduct a training session for a sport or participate in an object-based entertainment session, interact with the user terminal 720 to provide user input. For example, the user terminal 720 may include a session management application as part of its local session management logic. The session management application generates and displays one or more user interfaces via a display of the user terminal 720. User interaction with the user interfaces, such as the provision of input to the user interfaces via a touch screen, keyboard, mouse, or other input device, causes any of various operations within the studio 100 to initiate, change, end, or so on. For example, the user terminal 720 can receive input to log into a particular player’s profile, where the profile is stored as session data in the session data store and is stored in conjunction with various player information, such as records of past sessions by the player at the studio 100 or another related studio 100, player metrics during past sessions, and so on. User interaction with the user terminal 720 can also initiate a session at the studio 100, such as a training session for a sport, pause the session, end the session, or so on. User interaction with the user terminal 720 can initiate a replay video to be displayed, e.g., at the display 715, and/or to transfer a copy of the replay video to a digital location, such as emailing the replay video to a particular email address associated with the player. A person of skill in the art will recognize that various other user interactions are possible without deviating from the principles set forth herein, and those described above are present in various embodiments of the disclosure but are not necessary to every embodiment.

Wires 707, 713, 717, and 725A-725F communicatively couple components of the computing environment 700 in various embodiments. In some embodiments, some or all of the wires 707, 713, and 717 are instead network connections, e.g., are communication links among the ruggedized computer 705, object launcher 710, display 715, and user terminal 720 over the network 730. In various embodiments, some or all of wires 707, 713, 717, and 725A-725F are coaxial or shielded twisted-pair cables that transfer data using one or more protocols. In some embodiments, some or all of wires 707, 713, 717, and 725A-725F are other cables, such as fiber optic cables, universal serial bus (USB) cables, high-definition multimedia interface (HDMI) cables, DisplayPort cables, SATA cables, THUNDERBOLT cables, Ethernet cables, and/or Peripheral Component Interconnect Express (PCIe) cables, etc.

In some embodiments, data is transferred over some or all wires 707, 713, 717, and 725A-725F according to the GENERAL MOTORS SERIAL LINK 2 (GMSL2) communication protocol. GMSL2, originally designed for automobile computing systems, is a high-speed, high-bandwidth data transfer protocol typically used for automotive advanced driver-assistance systems (ADAS), automotive infotainment systems, and/or automotive camera systems. In various embodiments of the computing environment 700, GMSL2 is adapted to transfer data among some or all components of the computing environment 700. In particular, in some embodiments, the cameras 305A-305F rapidly transfer image data to the ruggedized computer 705 over the wires 725A-725F according to the GMSL2 protocol. In this manner, large quantities of image data can quickly reach the ruggedized computer 705 for processing, e.g., for use in the execution of object tracking logic, with minimal lag.

In some embodiments, some or all of wires 707, 713, 717, and 725A-725F have a maximum physical length limit, such as 5 meters, which can be due to data transfer rapidity requirements (e.g., of the object tracking logic) and/or standards of the data transfer protocol (e.g., GMSL2). As such, in various embodiments, the ruggedized computer 705 is disposed within the studio 100 proximate to the vertical camera arrays 115A-115B, e.g., within 5 meters of each vertical camera array 115A-115B. As a particular example, in some embodiments the ruggedized computer 705 is secured to the first face 105 of the studio 100. By including a ruggedized computer 705 proximate to the vertical camera arrays 105A-105B and hard-wired to the cameras 305A-305F of the vertical camera arrays 105A-105B using wires (or cables) 725A-725F within a certain threshold length that transfer data using a high-bandwidth protocol, various embodiments of the studio 100 provide for near-real-time (e.g., with lag time of less than one second, or less than one millisecond) object tracking functionality.

The network 730 and remote server 735 are components of the computing environment 700 in some embodiments. Various preferable embodiments do not include the network 730 and/or remote server 735, such as embodiments where the ruggedized computer 705 is communicatively coupled to the cameras 305A-305F, object launcher 710, display 715, and user terminal 720 by physical wires. In some embodiments, the ruggedized computer 705 is physically wired to the cameras 305A-305F and connected by the network 730 to one or more of the object launcher 710, display 715, and user terminal 720 rather than by way of physical wires. In some embodiments, the ruggedized computer 705 communicates some or all data received from the cameras 305A-305F, object launcher 710, display 715, and/or user terminal 720 to the remote server 735 via the network 730, and receives back instructions and/or data from the remote server 735 via the network 730, which instructions and/or data are sent by the ruggedized computer 705 to the cameras 305A-305F, object launcher 710, display 715, and/or user terminal 720. In some unpreferred embodiments, the computing environment 700 does not include a ruggedized computer 705, and some or all of the cameras 305A-305F, object launcher 710, display 715, and user terminal 720 are communicatively coupled with the remote server 735 via the network 730.

The network 730 is any combination of local area and/or wide area networks, using both wired and/or wireless communication systems. In various embodiments, the network 730 uses standard communications technologies and/or protocols. For example, the network 730 may include communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 730 can include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 730 may be represented using any suitable format, such as hypertext markup language (HTML) or extensible markup language (XML). In some embodiments, all or some of the communication links of the network 730 may be encrypted using any suitable technique or techniques.

The remote server 735 is a computing device physically separate from the computing environment 700, e.g., physically distanced from the studio 100 (which can include some or all of the computing environment 700, such as the vertical camera arrays 115A-115B and their respective cameras 305A-305F, the ruggedized computer 705, the object launcher 710, the display 715, the user terminal 720, and one or more physical communicative connections among the components of the computing environment 700, such as wires 725A-725F). In some embodiments, the remote server 735 executes some or all logic of the computing environment 700, such as logic of the ruggedized computer 705, object launcher 710, display 715, and/or user terminal 720. In some embodiments, the remote server 735 executes some or all session management logic and/or object tracking logic, which are described in further detail below, and/or the remote server 735 may host some or all data of the computing environment 700, such as a session database that includes historic session data and/or player metrics. In some embodiments, the remote server 735 hosts some or all of an AI model, such as an AI model employed by the object tracking logic. For example, the ruggedized computer 705 may send input, such as image data, over the network 730 to the AI model at the remote server 735, and receive back output from the AI model, such as one or more segmentations and/or classifications of image data.

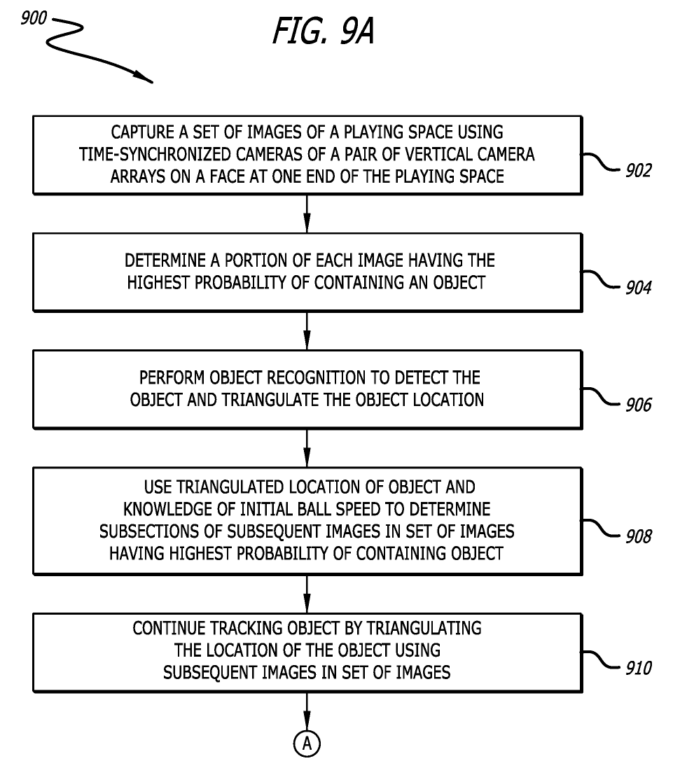

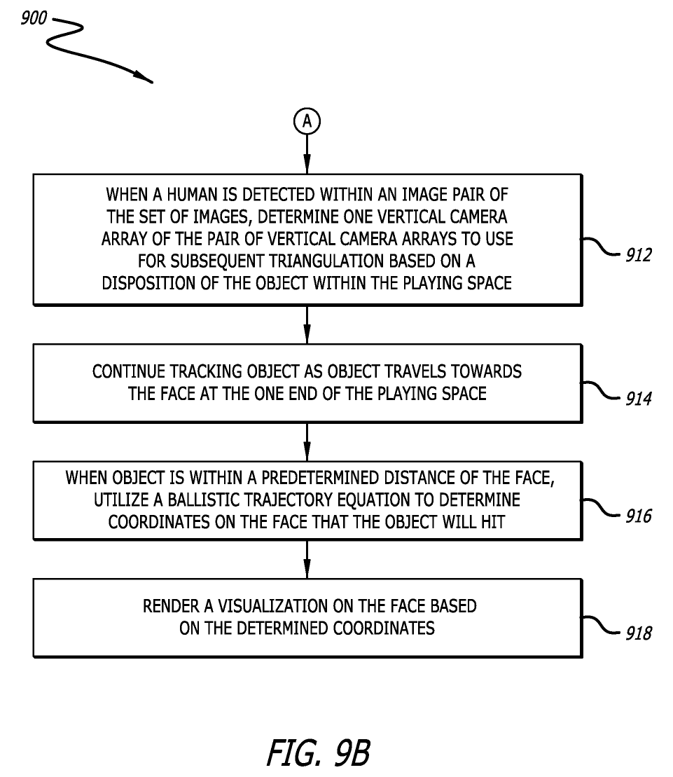

FIG. 8A is a block diagram illustrating logical components of a computing device, in accordance with some embodiments. The computing device 800 includes image acquisition logic 805, object tracking logic 810, session management logic 815, an object tracking data store 820, and a session data store 825. In other embodiments, the computing device 800 includes fewer, other, or additional logical components and/or data stores, and/or the functionality described herein may be distributed among the logical components differently than as described, without departing from the principles set forth herein. In various embodiments, the computing device 800 is the ruggedized computer 705. In other embodiments, the computing device 800 is the remote server 735, or a logical combination of functionality, processing capacity, and/or non-transitory computer-readable storage media distributed across some or all of the ruggedized computer 705, remote server 735, and/or user terminal 720. In various embodiments, logic of the computing device 805 performs operations implementing some or all logical steps of the processes described herein, such as some or all logical steps of the example processes described with reference to FIGS. 9-12 below.

The image acquisition logic 805 is software and/or hardware that provides image acquisition functionality. The image acquisition logic 805 performs operations to obtain images captured by the cameras 305A-305F. Such operations may include retrieving, i.e., querying or downloading, the captured images from a ring buffer of each camera 305A-305F. In some instances, the image acquisition logic 805 retrieves the captured time-synchronized images at a rate equal to the frame rate of the cameras. In some instances, the cameras 305A-305F are configured to capture images at a frame rate within the range of 80-100 frames/second. The retrieved images may be stored by the image acquisition logic 805 in the object tracking data store 820. In some embodiments, the captured images have an aspect ratio of 1920×1080 pixels.

The object tracking logic 810 is software and/or hardware that provides object tracking functionality. The object tracking logic 810 receives image data, e.g., image data ingested by the image acquisition logic 805, and performs any of a variety of object tracking operations based on the image data. For example, the object tracking logic 810 may retrieve image data from the object tracking data store 820, and/or receive and/or fetch image data from the image acquisition logic 805. The object tracking logic 810 is described in further detail below with reference to FIG. 8B below.

The session management logic 815 is software and/or hardware that provides session management functionality. In various embodiments, the session management logic 815 may be partially or wholly distributed at one or both of the computing device 800 and the user terminal 720. The session management logic 815 manages player sessions in the studio 100, and may access session programs stored in the session data store 825. For example, a player may interact with the user terminal 720, which sends instructions to the session management logic 815. The session management logic 815, in response to the received instructions, fetches a particular session program from the session data store 825, which may store a variety of session programs, such as training session programs or entertainment session programs.

The session management logic 815 exposes one or more user interfaces, e.g., user interfaces of a session management application, to the player (e.g., via the user terminal 720, to which the session management logic 815 may send instructions and/or graphical user interfaces for presentation). The session management logic 815 handles various user functionality, such as login, session program selection, pausing a session, generating player metrics for a session (e.g., generating one or more metrics based on data collected by the object tracking system during the session), presenting player metrics for a session, initiating presentation of a replay video (e.g., upon the display 715), and/or so on.

The object tracking data store 820 is a non-transitory computer-readable storage medium that stores data. For example, the object tracking data store 820 can include a relational or non-relational database, depending on the embodiment. The object tracking data store 820 stores object tracking data, such as image data from the cameras 305A-305F; output of one or more AI models, such as object segmentations and/or classifications; physical data such as coordinate knowledge of the positioning of the cameras 305A-305F, object launcher 121, and/or other components of the studio 100; launch parameters of an object; and/or any other data related to object tracking operations as described herein.

The session data store 825 is a non-transitory computer-readable storage medium that stores data. For example, the session data store 825 can include a relational or non-relational database, depending on the embodiment. The session data store 825 stores session data, such as player metrics determined during a session in the studio 100; historic session data, such as replay videos corresponding to past sessions; user profile information; one or more user interfaces, such as a user application for initiating, ending, or managing a session in the studio 100; and/or any other data related to sessions in the studio 100.

FIG. 8B is a block diagram illustrating logical components of an object tracking logic, such as the object tracking logic 810 of FIG. 8A, in accordance with some embodiments. The object tracking logic 810 includes a region of interest (ROI) detection logic 830, an object recognition logic 835, a triangulation logic 840, a coordinate determination logic 845, a human pose estimation logic 850, an outlier rejection logic 855, a replay generation logic 860, and an AI model 865. In other embodiments, the object tracking logic 810 includes fewer, other, or additional logical components and/or data stores, and/or the functionality described herein may be distributed among the logical components differently than as described, without departing from the principles set forth herein.

The ROI detection logic 830 is software and/or hardware that provides region of interest detection functionality. The ROI detection logic 830 performs operations that detect particular regions of interest within captured images. Such operations may include determination of a subsection of each captured image to analyze in attempting to detect a ball, a player and/or other objects, such as bottles, glasses, shoes, pets, etc. (and/or a player or a point of a body of the player). For instance, the ROI detection logic 830 may initially utilize the known locations of each camera of the object-tracking system and of the object launcher, as well as the known launch speed and launch orientation of an object, to determine a subsection (“the ROI”) of each captured image to analyze when attempting to find the object following its launch. Following the initial detection of the object, the ROI detection logic 830 may utilize previously analyzed images and the known launch speed and launch orientation to detect a subsection (the ROI) to analyze when attempting to track the object. In some embodiments, the size of the ROI may range from 100×100 pixels to 400×400 pixels. In some embodiments, the size of the ROI to be determined may be configurable prior to runtime. It should also be noted that the ROI need not be a square but may take other dimensions.

The object recognition logic 835 is software and/or hardware that provides object recognition functionality, e.g., performs object recognition processing, such as one or more of the processes described below. The object recognition logic 835 performs image analysis operations to analyze captured images and perform one or more of image classification, object localization, object detection and/or object segmentation (“object recognition”). Various techniques may be utilized to perform the object recognition including, for example, convoluted neural networks and/or other trained machine learning models, such as the AI model 865.

The triangulation logic 840 is software and/or hardware that provides triangulation functionality. The triangulation logic 840 performs triangulation operations using two captured images (captured at the same time, e.g., images taken by two cameras of a particular vertical camera array) that determine the location of the object and/or player(s) within the studio 110. The triangulated location information may be provided to the ROI detection logic 830 for use in determining the subsection of subsequent images for analysis.

Together, the analyses and processing of the captured images by the object recognition logic 835 and the triangulation logic 840 generate object-tracking data (or, with reference to the embodiments illustrated herein with respect to balls, e.g., soccer balls, “ball-tracking data”). The object-tracking data refers to data indicating one or more of the following: a location of a detected object within a plurality of captured images, a label of the detected object (i.e., identifying or classifying the object), a bounding box of the object and the object's location within the studio space at multiple times. For instance, the object-tracking data may include a listing of the object's location within the studio space at every 10 milliseconds subsequent to the launch of the object. However, other timing periods may be used, and the disclosure is not intended to be limited to 10 millisecond increments.

The coordinate determination logic 845 is software and/or hardware that provides coordinate determination functionality. The coordinate determination logic 845 performs operations that include execution of a ballistic trajectory equation based on the data obtained from tracking the object (i.e., continued determination of its triangulated location as the object travels toward the player and is then returned toward the screen 110). The ballistic trajectory equation results in a determination of a set of coordinates indicating a point on the screen 110 that the object is predicted to contact. The determined coordinates may be provided to the session management logic 815 for generation of instructions to cause a graphic to be displayed on the screen 110, for example, at the determined coordinates.

The human pose estimation logic 850 is software and/or hardware that provides human pose estimation functionality. The human pose estimation logic 850 performs operations to obtain images captured by the cameras of one or more vertical camera arrays, obtain object-tracking data as generated by the triangulation logic 840 and/or the ROI detection logic 830 indicating a location of the object and a player, when applicable, within the images captured by the cameras 305A-305F, segment the player and the object in the images captured by the cameras to generate a bounding box around the player, utilize epipolar geometry to project the bounding box onto a set of images captured by one or more cameras, perform a human pose estimation on the images captured by the cameras to identify points of the player's body, determine player-object interaction statistics (such as a touch sequence and/or dwell time) and optionally provide a human pose estimation to the replay generation logic 860.

The outlier rejection logic 855 is software and/or hardware that provides outlier rejection functionality. The outlier rejection logic 855 performs operations to remove outliers from data generated by the object recognition logic 835. For example, the object recognition logic 835 can generate object segmentations based on image data, where the object segmentations identify the object within image data. The outlier rejection logic 855 may employ the AI model 865 to segment one or more other aspects of the image data, such as a player and/or one or more parts of a body of the player captured in the image data. The outlier rejection logic 855 compares the segmentations of the one or more other aspects of the image data to the object segmentations to determine whether one or more of the object segmentations are false positives that correspond to an outlier, e.g., a player or a part of the body of the player that was improperly segmented by the object recognition logic 835 as the object. Upon identifying one or more false positives, the outlier rejection logic 855 removes the corresponding object segmentations from the data set, avoiding situations where the triangulation logic 840 would attempt to use improper object segmentations to triangulate a location of the object. As such, the outlier rejection logic 855 improves the accuracy and performance of the object tracking system.

The replay generation logic 860 is software and/or hardware that provides replay generation functionality. The replay generation logic 860 performs operations to generate replay videos for sessions in the studio 100. The replay generation logic 860 generates a sequence of panoramic replay images based on image pairs generated by the replay cameras, e.g., cameras 305B and 305E, by stitching the image pairs together into single panoramic images, where an overlapping region shared by the image pair is used by the replay generation logic 860 to map one image of the image pair onto the other for stitching together. The sequence of panoramic replay images are stored by the replay generation logic 860, e.g., at the session data store 825, and/or presented by the replay generation logic as a replay video, e.g., at the display 715.

The AI model 865 is software and/or hardware that provides artificial intelligence functionality, e.g., one or more machine-learned predictors, such as an object classification model and/or an object segmentation model. Depending upon the embodiment, the AI model can include one or more AI models, such as convolutional neural networks, recurrent neural networks, generative adversarial networks, autoencoders, object detection models, image segmentation models, Siamese neural networks, recurrent convolutional neural networks, contrastive language-image pre-training networks, and/or so on. In some embodiments, the AI model 865 is employed by the object recognition logic 835 in segmenting the object, the player, and/or one or more points of a body within image data.

In some embodiments, the object tracking logic 805 may also include a model training logic that trains the AI model 865. In an embodiment, the AI model 865 is trained by the model training logic using labeled image training data captured from multiple perspectives. In some embodiments, the model training logic trains the AI model 865 on labeled image training data from a side perspective of the studio 100, e.g., a labeled plurality of images captured from perspectives on sides C and D of the studio 100. Then the model training logic further trains the AI model 865 on labeled image training data based on images taken from the perspectives of the cameras 305A-305F of the vertical camera arrays 115A-115B (e.g., historical images taken by cameras of the vertical camera arrays). This two-part training approach can improve the performance of the AI model 865, e.g., in terms of accurately and precisely identifying objects, players, and/or one or more points of a body within image data.

In some embodiments, the object tracking logic 805 may also include a calibration logic that performs one or more calibration operations for each camera 305A-305F. For example, the calibration logic may perform an intrinsic calibration on each camera 305A-305F to determine the distortion that occurs when dewarping an image, and/or an extrinsic calibration for each camera pair (e.g., 305A and 305C, 305D and 305F, 305B and 305E) that determines how a flat plane of each camera relates to a flat plane of each other camera. The calibration logic may store parameters corresponding to the calibrations in the object tracking data store 820 for use in object tracking operations. The calibration logic may determine a transformation matrix corresponding to the transformation of a three-dimensional point in camera coordinates to world reference coordinates, for each camera pair, and store the transformation matrices in the object tracking data store 820. The calibration logic may, for each camera pair, create a two-dimensional grid of points that maps the overlapping views of each camera pair, and store the two-dimensional grids in the object tracking data store 820.

FIGS. 9A-9B are together a flowchart illustrating a method of tracking an object in the object tracking studio, in accordance with some embodiments. The object tracking system captures 902 a set of images of a playing space using time-synchronized cameras of a pair of vertical camera arrays on a face at one end of the playing space. System logic, e.g., the image acquisition logic 805, performs operations to obtain images captured by the cameras, e.g., querying, downloading or receiving, the captured images from a ring buffer of each camera. In some instances, the image acquisition logic retrieves the captured images at a rate equal to the frame rate of the camera. In some instances, the cameras of the object tracking system are configured to capture images at a frame rate within the range of 80-100 frames/second. The retrieved images may be stored in the object tracking data store 820.

The object tracking system determines 904 a portion of each image having the highest probability of containing an object. Based on knowledge of the disposition (e.g., physical placement and orientation) of each of the plurality of the cameras of the object tracking system and knowledge of the object launcher (including launch parameters of a launched object), system logic, e.g., the ROI detection logic 830, determines a portion of each image having the highest probability of containing the launched object. More specifically, based on the known launch parameters of an object, such as angle, orientation and speed, the ROI detection logic 830 estimates a location of the object within the studio 100 (e.g., within the volume of the playing space), wherein the estimated location corresponds to a position within captured images by two or more cameras of at least one vertical camera array at a given time. Thus, the ROI detection logic 830 determines a region of interest being a portion of the captured images having the highest probability of containing the object.

The object tracking system performs 906 object recognition to detect the object and triangulate the object location. Following the determination of the region of interest for a set of images, system logic, e.g., object recognition logic 835, performs operations to analyze the region of interest of the images in order to detect and identify a object. Once the object is detected and identified, system logic, e.g., triangulation logic 840, performs a triangulation process to determine a location of the object in 3D space using two captured images (of a particular vertical camera array) in which the object was identified. The object recognition data and the triangulated location of the object along with the captured images and a corresponding timestamp (collectively “object-tracking data”) may be stored in, for example, the object tracking data store 820.

The object tracking system uses the triangulated location of the object and knowledge of an initial object speed to determine 908 subsections of subsequent images in the set of images having a highest probability of containing the object. Upon determination of a triangulated location of the object, the ROI detection logic 830 in combination with the triangulation logic 840 determines a subsection of subsequent images having the highest probability of containing the object. In some embodiments, following the determination of a triangulated location of the object in multiple (e.g., three) pairs of captured images, the ROI detection logic 210 utilizes the triangulated locations to estimate a subsection of a subsequently captured image having the highest probability of containing the object. In such embodiments, prior to the determination of the triangulated location of the object in multiple captured images, the ROI detection logic 830 continues determination of the subsection of each captured image having the highest probability of containing the object using the launch parameters and known configuration of the cameras.

Further, in some embodiments when the set of captured images for a given time does not contain the object (or the object otherwise goes unidentified), the ROI detection logic 830 may revert to using the launch parameters of the object to estimate the subsection of subsequent captured images having the highest probability of containing the object (until a triangulated location of the object is identified for a predetermined number of captured images, e.g., three).

The object tracking system continues tracking 910 the object by triangulating the location of the object using subsequent images in the set of images. The triangulation logic 840 continues to execute for subsequent images (e.g., image pairs from at least one vertical camera array). When a human is detected within an image pair of the set of images, the object tracking system determines 912 one vertical camera array of the pair of vertical camera arrays to use for subsequent triangulation based on a disposition of the object within the playing space. As described above, the pair of vertical camera arrays are on either side of a midline dividing the playing space in half along an axis from side A to side B. A first portion of the playing space may be on a side of the midline closer to side C and a second portion of the playing space may be on a side of the midline closer to side D. The object tracking system, e.g., triangulation logic 840, determines whether the object is in the first portion or second portion. When the object is in the first portion, the object tracking system continues to triangulate the object using image pairs from the vertical camera array closer to side D, and when the object is in the second portion, the object tracking system continues to triangulate the object using image pairs from the vertical camera array closer to side C. In this manner, the object tracking system is more efficient than prior techniques by avoiding complexities of those prior techniques that increased the involved computing time, such as determining various Euclidian distances between the object and player in various pairs of image data to determine which respective pair of cameras to use for subsequent triangulation.

The object tracking system continues tracking 914 the object as the object travels towards the face at the one end of the playing space. Prior to this tracking 914, the object tracking system captures an interaction between the player and the object, and each of the player and the object is identified by the object tracking system (e.g., based on object recognition using image pairs from the determined one vertical camera array). In embodiments in which an object-tracking system is applied to soccer (“football” in the UK), a player 116 typically receives a ball launched from the object launcher positioned behind the screen 110, performs some interaction with the ball (e.g., trap and touch), and kicks the ball back toward the screen 110 (e.g., at a virtual goal that is displayed on the screen 110).

As is discussed herein, the entire sequence of the ball traveling toward the player, the player receiving and interacting with the ball, and the ball returning toward the screen is captured by the cameras of at least one of the pair of vertical camera arrays. Further, system logic determines a location of the ball (and optionally the player) within the volume of the playing space through triangulation using a pair of images from a vertical camera array. Thus, the ball is tracked by the object tracking system from the time it is initially identified following launch to when it is received by the player and as it travels away from the player toward the screen 110.

When the object is within a predetermined distance of the face, the object tracking system utilizes 916 a ballistic trajectory equation to determine coordinates on the face that the object will hit. As the object is continually tracked as discussed above, the system logic, e.g., the triangulation logic 840, determines when the object is within a predetermined distance from the screen 110. In such an instance, the coordinate determination logic 845 performs processing on the triangulated location using a ballistic trajectory equation to determine coordinates of the screen 110 that the ball is expected to hit. In some embodiments, the coordinate determination logic 845 is initiated when the triangulation logic 840 determines that the object is 75 cm away from the screen 110. In other embodiments, the coordinate determination logic 845 is initiated when the triangulation logic 840 determines that the object is 60 cm away from the screen 110. However, the distance of the object away from the screen at which the coordinate determination logic 845 is activated is configurable prior to runtime.

The object tracking system renders 918 a visualization on the face based on the determined coordinates. The object tracking system may generate and transmit to the projector (or other display module) instructions that cause the rendering of a visualization on the screen based on the determined coordinates. In some embodiments, the instructions are transmitted after a predetermined time-delay or include a time-delay. Such embodiments provide a solution for the situation in which the coordinates are determined prior to the object traveling approximately 60-75 cm to contact the screen 110 such that the time-delay enables the rendering of the visualization to be fluid and in sync with the object contacting the screen. In some instances, the time-delay is predetermined while in other embodiments, the time-delay may be determined during run-time based on the speed of the object when the object is approximately 60-75 cm away from the screen 110.

As non-limiting examples, the visualization may include a ball being shot past a goalie indicating a goal was scored by the player or a ball being stopped by the goalie. However, as noted above, the visualizations provided need not correspond directly to a representation of a sporting event but may instead include fanciful or imaginative gameplay such as a ball extending into the screen to break up a meteor approaching the screen or knock over a zombie displayed on the screen. The gameplay illustrated on the screen may take on any embodiment.

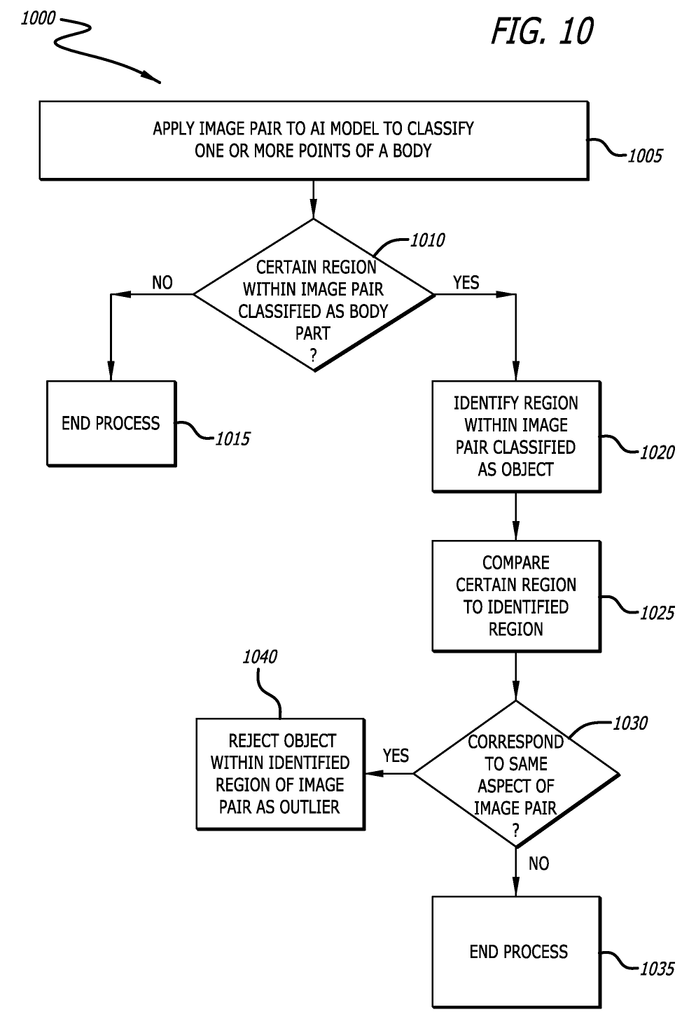

FIG. 10 is a flowchart illustrating a method 1000 of rejecting outliers in an object tracking technique, in accordance with some embodiments. The object tracking system may perform the method for any number of image pairs in image data. The object tracking system applies an AI model to an image pair resulting in classification one or more points of a body, which may include providing the image pair as input to the AI model (operation 1005). In some embodiments, the object tracking system applies, for each of the one or more points of the body, the image pair to a respective AI model to segment regions of the image pair corresponding to the respective point of the body.

The object tracking system determines whether at least one region within the image pair was classified as a body part (e.g., a point on the body, such as a hand, a foot, or a head) (operation 1010). If not, the object tracking system ends the method for the image pair (operation 1020). If at least one region within the image pair was classified as a body part, the object tracking system identifies a region in the image pair classified as an object, e.g., provides the image pair to an object segmentation AI model to produce an object segmentation (operation 1020).

The object tracking system compares the one or more segmented regions corresponding to one or more points of the body to the object segmentation and determines whether one of the certain regions corresponding to one or more points of the body corresponds to a same aspect of the image pair as the identified region in the object segmentation (operations 1025, 1030). If none of the certain regions correspond to the identified region, the object tracking system ends the method (operation 1035). If a certain segmented region corresponding to one or more points of the body corresponds to the identified region corresponding to the object, the object tracking system rejects the object segmentation for the image pair as an outlier (operation 1040). For example, a head wearing a white hat captured within an image pair may be falsely classified as a soccer ball, and the object tracking system may segment the head within the image pair and determine that the falsely classified soccer ball is actually a head, and thus remove the false object segmentation from the set of object segmentations produced by the object tracking system (e.g., as part of object recognition logic).

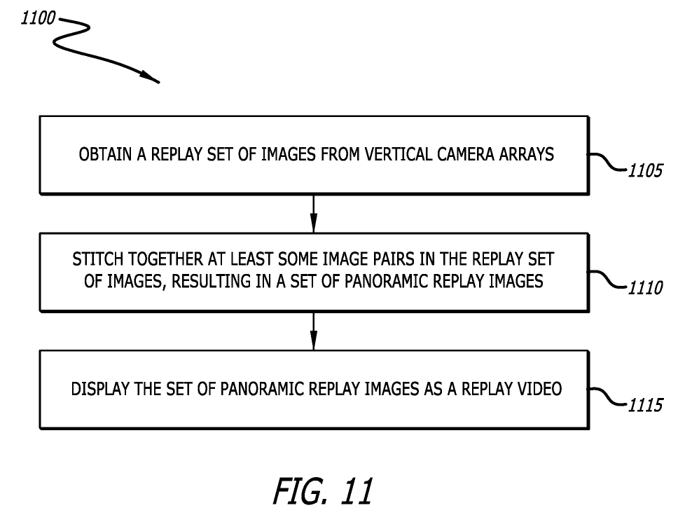

FIG. 11 is a flowchart illustrating a method 1100 of generating a replay video, in accordance with some embodiments. The object tracking system obtains a replay set of images from the vertical camera arrays 115A-115B (operation 1105). In some embodiments, the replay set of images come from dedicated replay cameras, e.g., cameras 305B and 305E. By positioning the replay cameras between the object tracking cameras of each vertical camera array 115A-115B, the studio 100 captures replay images at approximately a player’s eye level, which may be desirable to the player.

The object tracking system stitches together at least some image pairs in the replay set of images, resulting in a set of panoramic replay images (operation 1110). In some embodiments, the object tracking system determines a subset of the replay set of images that contain the object, e.g., the object tracking system performs object segmentation on the replay set of images and removes image pairs that do not correspond to object segmentations. The object tracking system, for each image pair of the at least some image pair, determines a region of overlap shared by the images of the image pair. The object tracking system stitches the images together based on the region of overlap, e.g., removing the region of overlap from one of the images and combining the remaining image data of the one image with the other image such that the remaining image data of the one image is stitched proximate to the region of overlap in the other image. This results in a wider image than either individual image of the image pair, a “panoramic replay image.” The at least some image pairs are in a particular sequence, e.g., in time series order according to respective timestamps, and the corresponding panoramic replay images are sequenced similarly, e.g., in a same order, by the object tracking system. The object tracking system displays the set of panoramic replay images (e.g., in sequence) as a replay video (operation 1105). In alternative embodiments, the object tracking system displays the set of panoramic replay images on the display as still images.

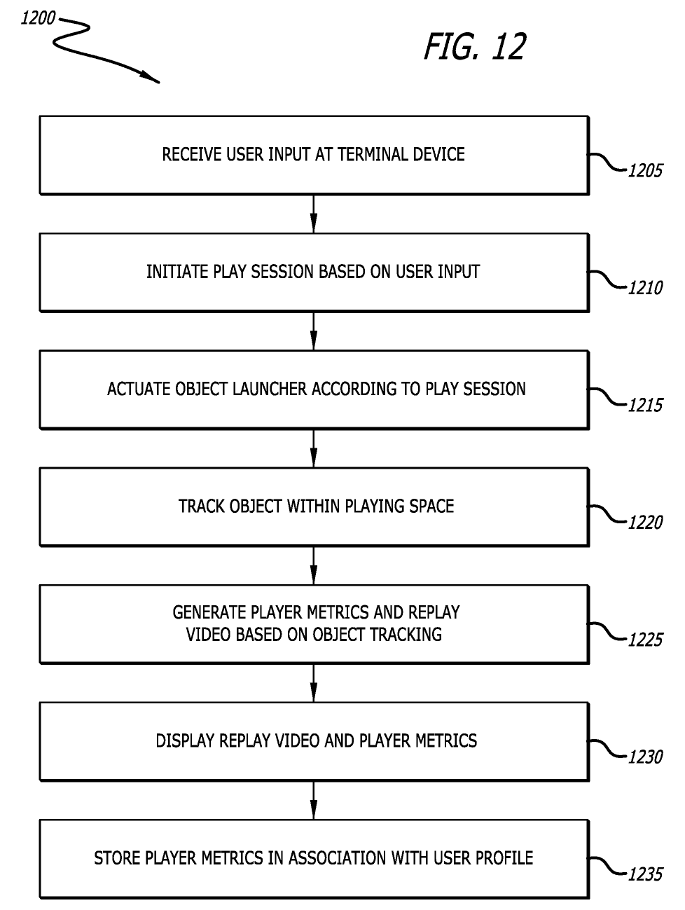

FIG. 12 is a flowchart illustrating a method 1200 of user experience in the object tracking studio, in accordance with some embodiments. The object tracking system (e.g., the studio 100) receives user input at a terminal device, such as user terminal 720 (operation 1205). The object tracking system initiates a play session based on the user input (operation 1210). For example, the user input may indicate a particular training session program, which the object tracking system initiates within the studio 100.

The object tracking system actuates an object launcher, e.g., object launcher 710, according to the play session (operation 1215). The particular play session may indicate a number of objects to be launched, a frequency with which to launch the objects, a velocity with which to launch the object, and/or a spin with which to launch the object. The object tracking system tracks the object within the playing space after it is launched (operation 1220). For example, the object tracking system executes object tracking logic 810.

The object tracking system generates player metrics and a replay video based on the object tracking (operations 1225). This can involve the object tracking system performing the process of FIG. 11, for example. In some examples, the player metrics generated by the object tracking system can include a dwell time that measures a period of time measured from an initial point of contact between the object and the player until the object begins traveling away from the player. For instance, the object tracking system may employ the object tracking logic 810 to segment the object and the player in the image data and generate a bounding box around the player. The object tracking system performs human pose estimations on the images to identify one or more points of the player’s body, and/or uses an AI model to segment the one or more points of the player’s body. The object tracking system identifies the player’s location in three-dimensional space based on the player segmentation data and, in combination with the pose estimations and object segmentations, determines player-object interaction metrics, such as the aforementioned dwell time, and/or a touch sequence, and/or other metrics. The object tracking system may be configured to display the replay video and player metrics, e.g., via the display 715 (operation 1230). The object tracking system may store the player metrics in association with a user profile of the player in the session data store 825 (operation 1235). In some embodiments, the object tracking system also stores the replay video in the session data store 825.

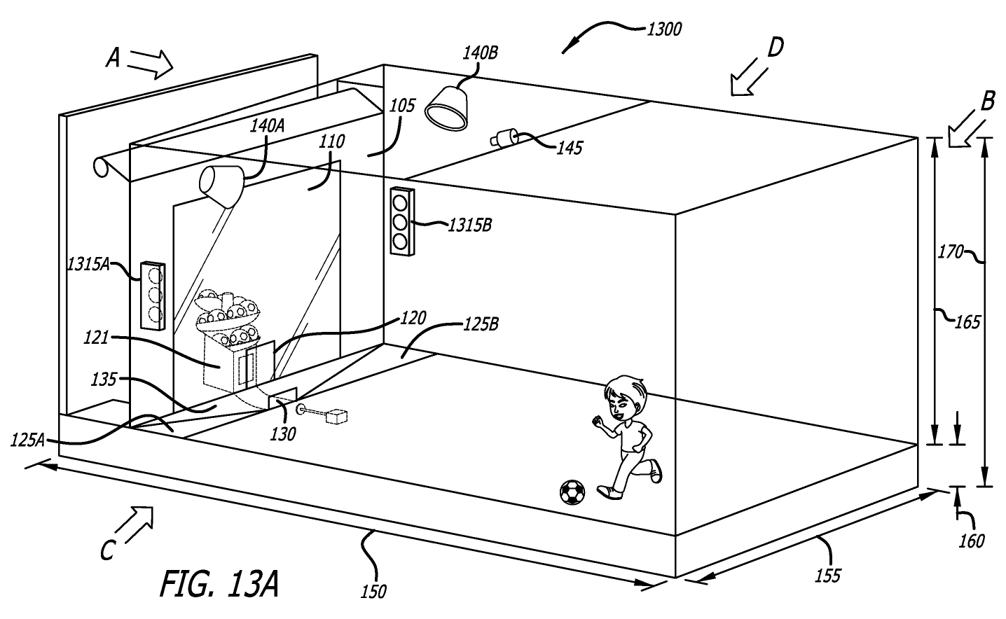

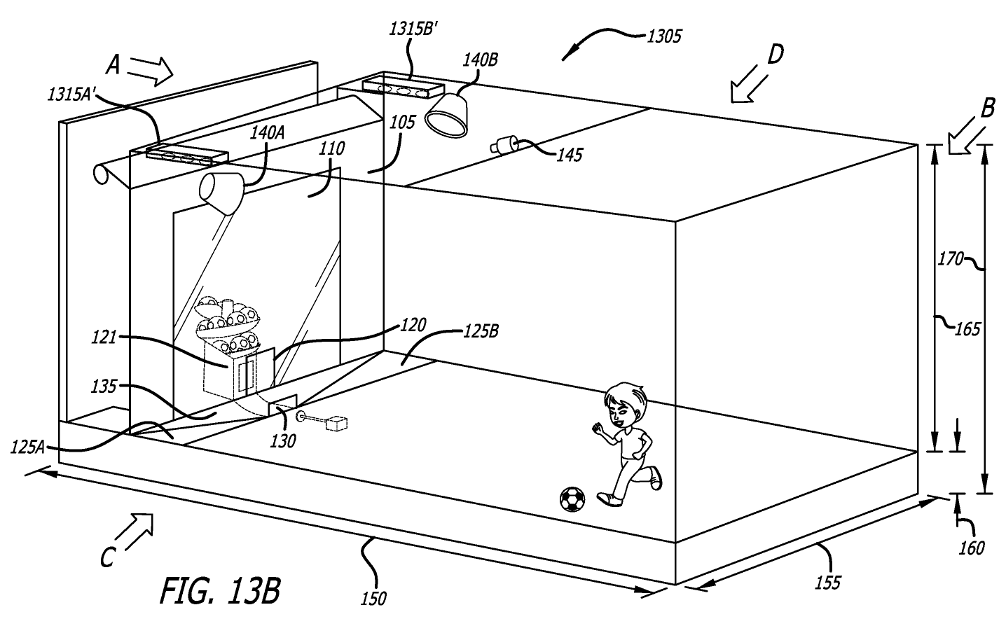

FIG. 13A illustrates a second object tracking studio, in accordance with some embodiments. The object tracking studio (“studio”) 1300 is similar in many instances to the studio 100 discussed with respect to at least FIG. 1A. For example, the studio 1300 includes a playing space, which is a volume defined by boundaries of the studio 1300. For example, the playing space can be considered the volume defined by playing space length measurement 150, playing space width measurement 155, and playing space height measurement 165. The studio 1300 also includes a plurality of cameras utilized to track an object within the playing space. In the embodiment of the figure, the studio 1300 includes a pair of vertical camera arrays 1315A-1315B that are configured to operate in the same manner as the pair of vertical camera arrays 115A-115B of FIG. 1A. For instance, the pair of vertical camera arrays 1315A-1315B may be utilized as a component of the object-tracking system and methods associated therewith in place of the pair of vertical camera arrays 115A-115B.

Briefly, the studio 1300 is configured for a human (e.g., a player) to receive an object (e.g., a ball) from an object launcher via an object launcher opening 120 in a first face 105 of the studio 1300, e.g., a wall, and return the object in the direction of the first face 105. The object launcher is described in further detail above, e.g., with reference to FIG. 1B. As with FIG. 1A, in the illustrative embodiment shown, the studio 1300 comprises a rectangular-shaped studio space, where sides of the studio 100 are labeled as A-D (e.g., the first face 105 is on side A of the studio 100). In other embodiments, the studio 1300 may have other shapes, such as a trapezoidal shape where side B, opposite the first face 105, has several faces.

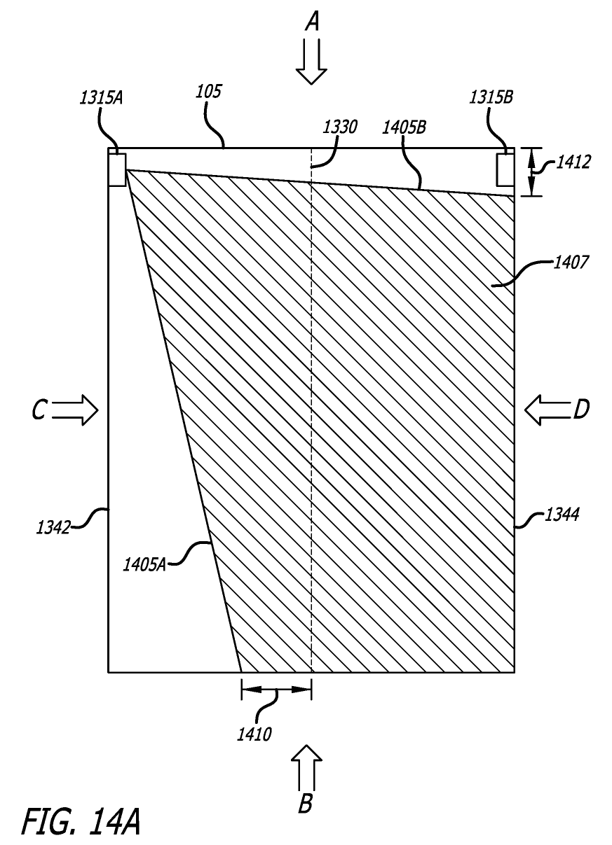

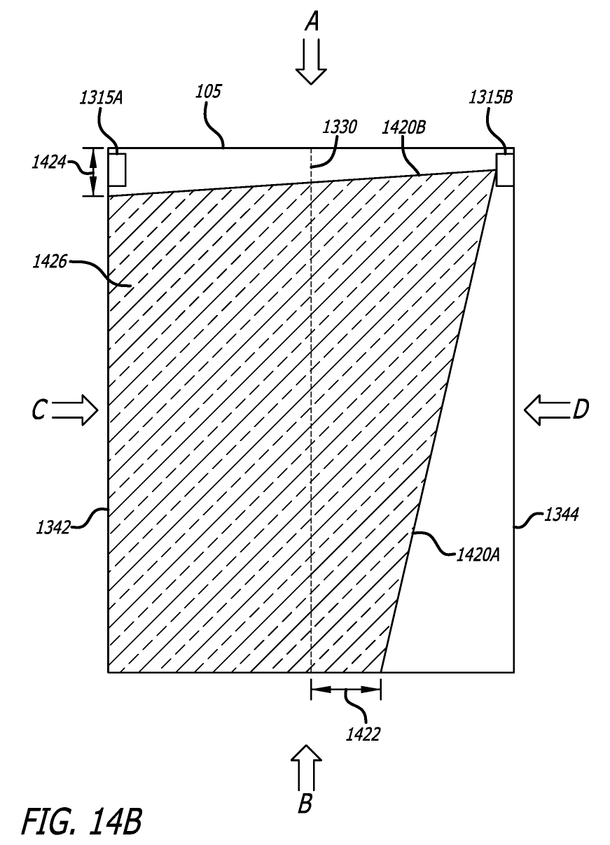

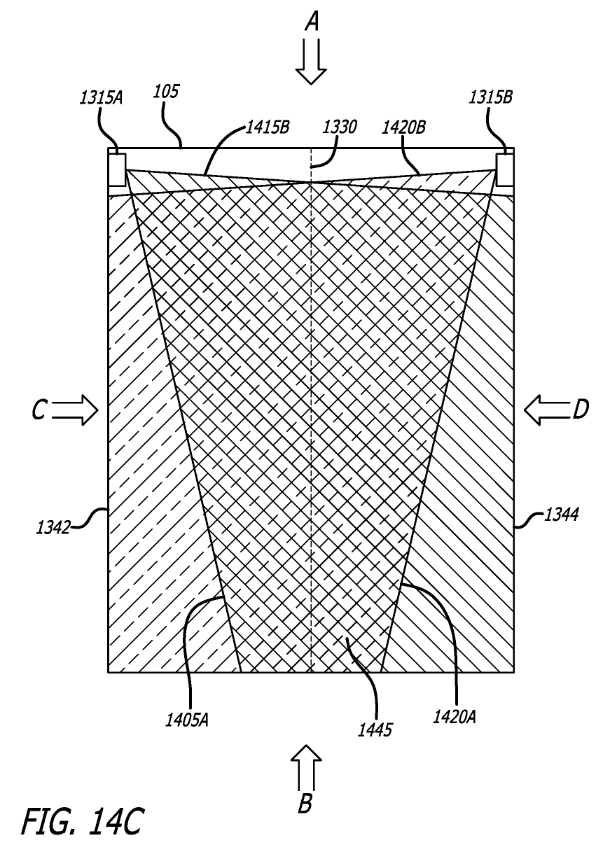

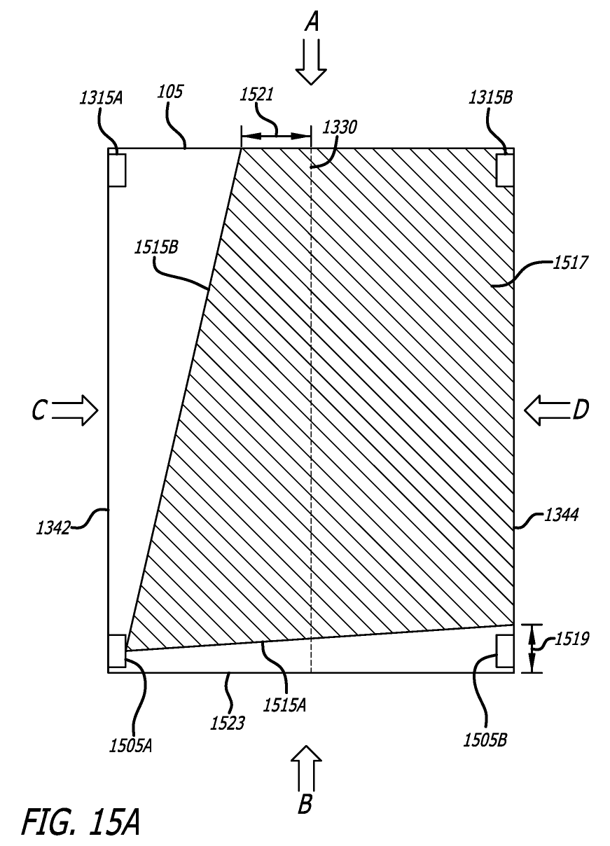

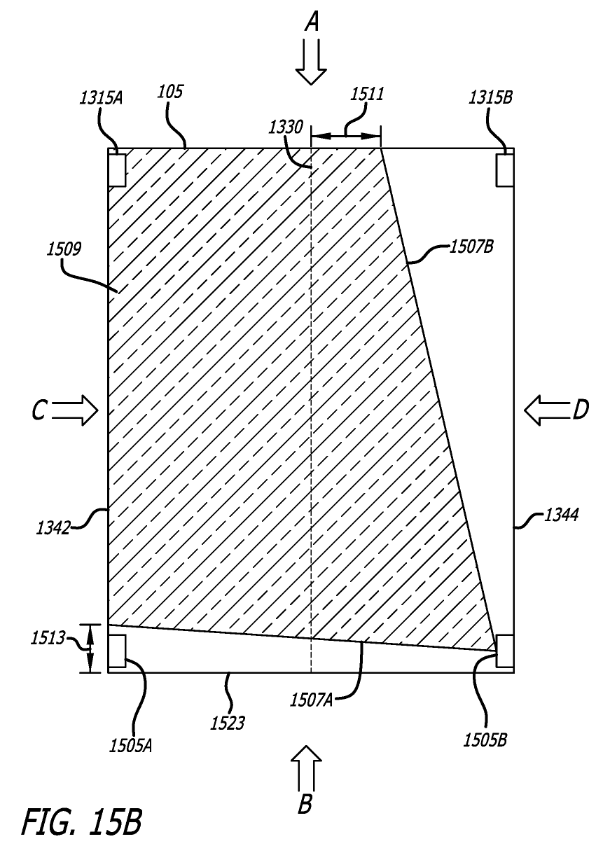

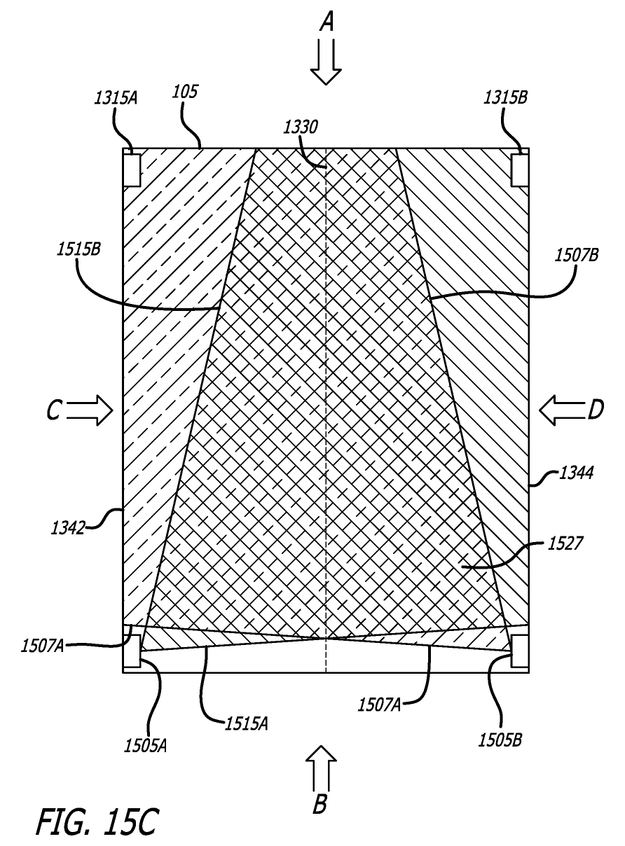

Additional detail of the studio 1300 is substantially equivalent to that discussed regarding the studio above. However, the pair of vertical camera arrays 1315A-1315B of the studio 1300 are shown to be disposed on the side walls of the studio 1300, e.g., side walls corresponding to sides C and D. As illustrated in at least FIGS. 14A-15C, the pair of vertical camera arrays 1315A-1315B captures images of the studio 1300, which are passed to logic modules (logics) discussed throughout the disclosure. It should be understand that the pair of vertical camera arrays 1315A-1315B may be positioned at any height within the playing space height measurement 165 (the arrays positioned at equal heights) and/or on the ceiling of the studio 1300 (as further illustrated in FIG. 13B) and positioned at equal distance away from the first face 105.

The logic of the object-tracking system, with is described in further detail, may execute various logics, such as an object tracking logic, and may further execute a ballistic trajectory equation using parameters obtained through tracking the object to determine a point on the screen 110 at which the object will, or is expected, to contact. The logic may further generate and transmit instructions to the projector 145 to display a graphic, visualization, etc., on the screen 110 based on the determined point. The instructions may be transmitted via a wired and/or wireless connection from a computing device to the projector 145 (or screen 110 itself, in some embodiments). As is illustrated discussed more below, the logic may include a plurality of logic modules that are stored on non-transitory, computer-readable medium of a computing device, which may be located within a local computer or remotely, e.g., stored and processed within a cloud computing environment. Thus, it should be understood that the positioning of the pair of vertical camera arrays 1315A-1315B does not alter the operations and methodologies performed by the logic of the object-tracking system disclosed herein.

In further detail, the object-tracking system includes a specific configuration of cameras (e.g., the pair of vertical camera arrays 1315A-1315B) to capture images of the playing space following the launch of a ball. The cameras are positioned in a mirrored configuration within vertical camera arrays such that the cameras of each vertical camera array are at mirrored positions relative to a center axis 1330 as shown in FIGS. 4A-4C (e.g., the midline of the playing space) that runs from side A to side B. In other words, respective cameras of each vertical camera array are located an equal distance away from the screen 110 towards opposing sides of the studio environment, e.g., sides C and D. Additionally, the cameras of the object-tracking system are time-synchronized such that each camera captures an image at the same time. As was discussed, time-synchronization enables the accompanying logic to triangulate the position of the object using an image pair (i.e., two images captured from two separate cameras at the same time). In some examples, the images captured by any two cameras of the pair of vertical camera arrays 1315A-1315B may be utilized to triangulate the position of the object.

FIG. 13B illustrates a third object tracking studio, in accordance with some embodiments. The object tracking studio (“studio”) 1305 is similar in many instances to the studios 100, 1300 discussed with respect to at least FIG. 1A and 13A, respectively. For example, the studio 1305 includes a playing space, which is a volume defined by boundaries of the studio 1305. For example, the playing space can be considered the volume defined by playing space length measurement 150, playing space width measurement 155, and playing space height measurement 165. The studio 1305 also includes a plurality of cameras utilized to track an object within the playing space. In the embodiment of the figure, the studio 1305 includes a pair of camera arrays 1315A’-1315B’ that are configured to operate in the same manner as the pair of vertical camera arrays 1315A-1315B of FIG. 13A. For instance, the pair of camera arrays 1315A’-1315B’ may be utilized as a component of the object-tracking system and methods associated therewith in place of the pair of vertical camera arrays 115A-115B. Differently than that of the illustration of the pair of camera arrays 1315A-1315B in FIG. 13A, the pair of camera arrays 1315A’-1315B’ are specifically illustrated as being positioned on the ceiling of the studio 1305. As the operability of the pair of camera arrays 1315A’-1315B’ is the same as that of the pair of camera arrays 1315A-1315B, such will not be repeated here.

FIGS. 14A-14C are top-down views of the object tracking studio illustrating a cross section of the fields of view of cameras of vertical camera arrays, in accordance with some embodiments. FIG. 14A illustrates a top-down view of the fields of view of cameras of vertical camera array 1315A, particularly an area of the floor surface area of the playing space within the fields of view of the cameras of vertical camera array 1315A, according to some embodiments. As discussed above, each camera of vertical camera array 1315A also includes in its field of view a vertical component from the floor surface area to the ceiling of the studio 1300. The area of the floor surface area within the fields of view 1407 of the cameras of vertical camera array 1315A is shaded in the figure, and is bound by field of view limit (“limit”) 1405A and field of view limit 1405B. As illustrated, the fields of view 1407 are limited 1405A a distance 1412 from the first face 105. As discussed above, the object tracking system estimates a trajectory of the object from the limit 1405A to the first face 105, e.g., over the distance 1412. This distance 1412 is reduced by angling the vertical camera array 1315A towards the midline 1330. The fields of view 1407 also include part of the first portion of floor surface area, e.g., an area partially defined by limit 1405B and the midline 1330. The fields of view 1407 continue to a point on side B that is distance 1410 along side B into the first portion of floor surface area. By capturing some of the first portion of floor surface area in the fields of view 1407 of vertical camera array 1315A, the object tracking system can, among other operations described further below, generate a panoramic replay video based in part on images captured by cameras of the vertical camera array 1315A.

FIG. 14B illustrates a top-down view of the fields of view of cameras of vertical camera array 1315B, particularly an area of the floor surface area of the playing space within the fields of view of the cameras of vertical camera array 1315B, according to some embodiments. As discussed above, each camera of vertical camera array 1315B also includes in its field of view a vertical component from the floor surface area to the ceiling of the studio 1300. The area of the floor surface area within the fields of view 1426 of the cameras of vertical camera array 1315B is shaded in the figure, and is bound by field of view limit 1420A and field of view limit 1420B. As illustrated, the fields of view 1426 are limited 1420B a distance 1424 from the first face 105. The distance 1424 is typically equivalent to distance 1412 due to the mirrored configuration of the vertical camera arrays. As discussed above, the object tracking system estimates a trajectory of the object from the limit 1420B to the first face 105, e.g., over the distance 1424. This distance 1424 is reduced by angling the vertical camera array 1315B towards the midline 1330. The fields of view 1426 also include part of the second portion of floor surface area, e.g., an area partially defined by limit 1420A and the midline 1330. The fields of view 1426 continue to a point on side B that is distance 1422 alongside B into the second portion of floor surface area. By capturing some of the second portion of floor surface area in the fields of view 1426 of vertical camera array 1315B, the object tracking system can, among other operations described further below, generate a panoramic replay video based in part on images captured by cameras of the vertical camera array 1315B.

FIG. 14C illustrates a top-down view of a cross section of the fields of view of cameras of both vertical camera arrays 1315A-1315B, according to some embodiments. An overlapping region 1445 of floor surface area is captured in images taken by cameras of both vertical camera arrays 1315A-1315B. As such, objects and/or humans within the overlapping region 1445 can be identified in images taken by either of the vertical camera arrays 1315A-1315B. Between the vertical camera arrays 1315A-1315B, almost the entirety of the playing space is within the fields of view of the cameras collectively within the studio 1300. Only certain regions close to the first face 105 are not captured by at least one of the fields of view. In this manner, objects nearly anywhere in the playing space will be captured by cameras of at least one vertical camera array 1315A-1315B. For example, an object in the corner of sides C and B will appear in images captured by vertical camera array 1315B, and an object in the corner of sides D and B will appear in images captured by vertical camera array 1315A. Furthermore, the overlapping region 1445 allows the object tracking system to stitch together images from the first vertical camera array 1315A and the second vertical camera array 1315B to produce panoramic replay images that can form a replay video, as described in further detail below. For example, images utilized by the logic discussed may be captured by a top camera of the first vertical camera array 1315A and a bottom camera of the second vertical camera array 1315B. However, images from other pairings may be utilized (e.g., both top cameras, both bottom cameras, a bottom camera of the first vertical camera array 1315A and a top camera of the second vertical camera array 1315B).

FIGS. 15A-15C are top-down views of the object tracking studio illustrating a cross section of the fields of view of cameras of vertical camera arrays, in accordance with some embodiments. In the examples of FIGS. 15A-15C, the studio 1300 additionally includes another pair of vertical camera arrays 1505A-1505B disposed proximate to side B of the studio 1300. The pair of vertical camera arrays 1505A-1505B may be positioned at any height within the playing space height measurement 165 (the arrays positioned at equal heights) and/or on the ceiling of the studio 1300 (and positioned at equal distance away from the first face 105). In various embodiments, image data from the vertical camera arrays 1505A-1505B may be used with image data from vertical camera arrays 1315A-1315B to perform object tracking operations. In particular, image data from vertical camera arrays 1505A-1505B can be used to improve the accuracy of object tracking operations, such as object segmentation, classification, position estimation, and trajectory estimation. As a particular example, image data from vertical camera arrays 1505A-1505B can be used to track the object as it reaches the first face 105, avoiding the need for trajectory estimation (e.g., over distance 1412 or distance 1424).

FIG. 15A illustrates a top-down view of the fields of view of cameras of third vertical camera array 1505A, particularly an area of the floor surface area of the playing space within the fields of view of the cameras of vertical camera array 1505A, according to some embodiments. Each camera of vertical camera array 1505A also includes in its field of view a vertical component from the floor surface area to the ceiling of the studio 1300. The area of the floor surface area within the fields of view 1517 of the cameras of vertical camera array 1505A is shaded in the figure, and is bound by field of view limit 1515A and field of view limit 1515B. As illustrated, the fields of view 1517 are limited 1515A a distance 1519 from the face 1523 of the studio at side B. The fields of view 1517 also include part of the first portion of floor surface area, e.g., an area partially defined by limit 1515B and the midline 1330. The fields of view 1517 continue to a point on the first face 105 that is distance 1521 along the first face 105 into the first portion of floor surface area. By capturing some of the first portion of floor surface area in the fields of view 1517 of vertical camera array 1505A, the object tracking system can, among other operations described further below, generate a panoramic replay video based in part on images captured by cameras of the vertical camera array 1505A (e.g., a from-the-rear replay video).

FIG. 15B illustrates a top-down view of the fields of view of cameras of vertical camera array 1505B, particularly an area of the floor surface area of the playing space within the fields of view of the cameras of vertical camera array 1505B, according to some embodiments. Each camera of vertical camera array 1505B also includes in its field of view a vertical component from the floor surface area to the ceiling of the studio 1300. The area of the floor surface area within the fields of view 1509 of the cameras of vertical camera array 1505B is shaded in the figure, and is bound by field of view limit 507A and field of view limit 507B. As illustrated, the fields of view 1509 are a distance 513 from the face 523 of the studio at side B. The fields of view 1509 also include part of the second portion of floor surface area, e.g., an area partially defined by limit 507B and the midline 1330. The fields of view 1509 continue to a point on side B that is distance 511 along the first face 105 into the second portion of floor surface area. By capturing some of the second portion of floor surface area in the fields of view 1509 of vertical camera array 1315B, the object tracking system can, among other operations described further below, generate a panoramic replay video based in part on images captured by cameras of the vertical camera array 1505B (e.g., a from-the-rear replay video).

FIG. 5C illustrates a top-down view of a cross section of the fields of view of cameras of both vertical camera arrays 1505A-1505B, according to some embodiments. An overlapping region 1527 of floor surface area is captured in images taken by cameras of both vertical camera arrays 1505A-1505B. As such, objects and/or humans within the overlapping region 1527 can be identified in images taken by either of the vertical camera arrays 505A-B. Between the vertical camera arrays 1505A-1505B, almost the entirety of the playing space is within the fields of view of the cameras collectively within the studio 1300, and in combination with vertical camera arrays 1315A-1315B, the entirety of the playing space is within the fields of view of the cameras of the vertical camera arrays collectively.

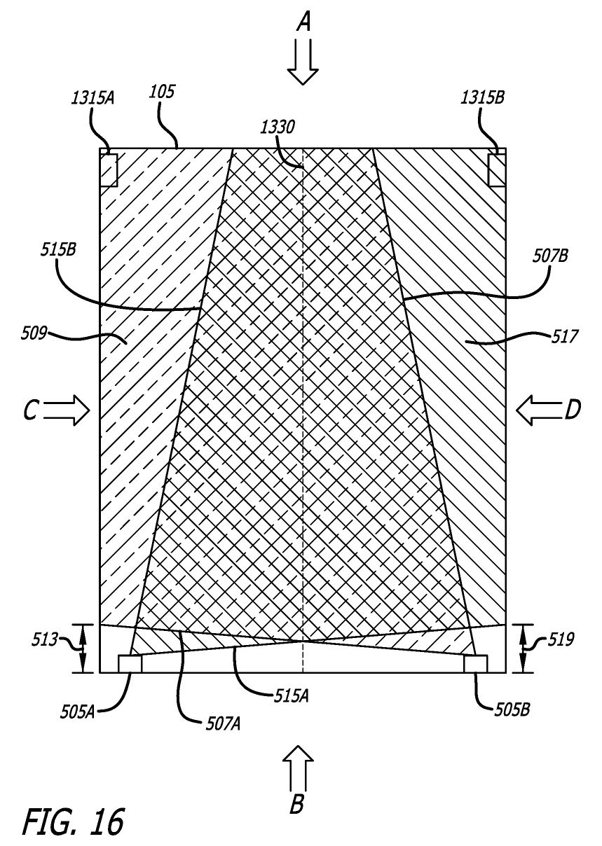

FIG. 16 illustrates a top-down view of a cross section of the fields of view of cameras of both vertical camera arrays 505A-505B of FIG. 5C, according to some embodiments. FIG. 16 illustrates that the vertical camera arrays 1315A-1315B may also be utilized in connection with the vertical camera arrays 505A-505B, the operability of which are discussed above and will not be repeated here.

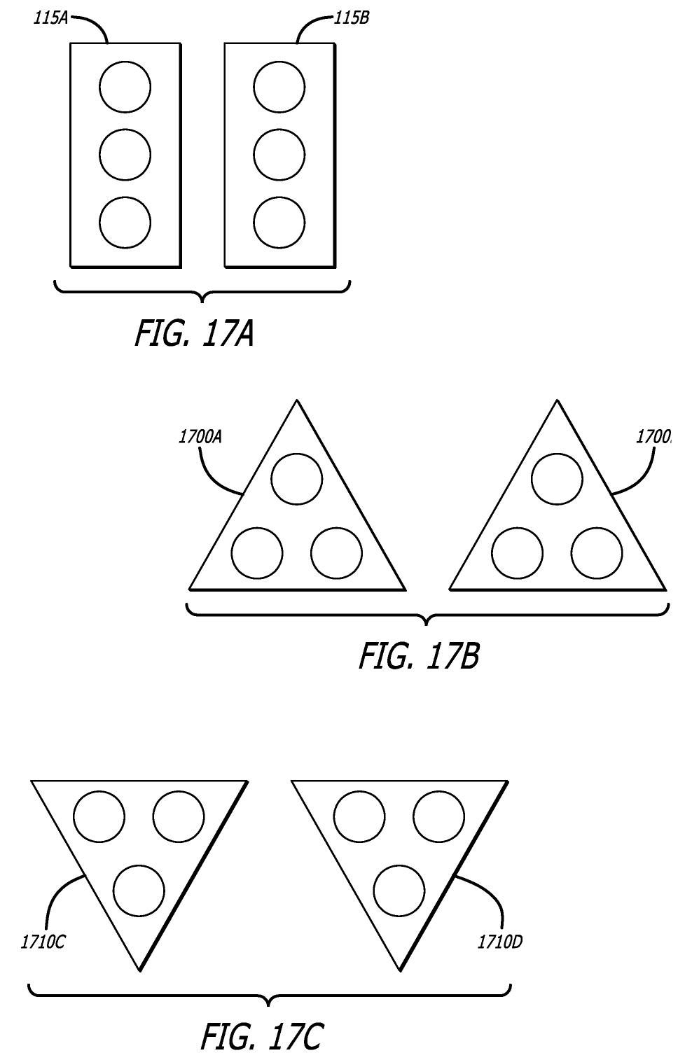

FIGS. 17A-17C are illustrations of example configurations of camera array pairs, in accordance with some embodiments. FIG. 17A illustrates an example of the pair of vertical camera arrays 115A-115B as discussed above. FIGS. 17B-17C illustrate examples of alternative configurations of camera arrays. FIG. 17B provides a first triangular configuration of camera array pairs 1700A-1700B and FIG. 17C provides a second triangular configuration of camera array pairs 1710C-1710D. The various configurations of camera array pairs shown in FIGS. 17A-17C may be utilized in any of the various embodiments disclosed above. For example, while many of the embodiments disclosed above recite “vertical camera arrays,” the triangular configurations of FIG. 17B-17C may be utilized instead.

While some particular embodiments have been disclosed herein, and while the particular embodiments have been disclosed in some detail, it is not the intention for the particular embodiments to limit the scope of the concepts provided herein. Additional adaptations and/or modifications can appear to those of ordinary skill in the art, and, in broader aspects, these adaptations and/or modifications are encompassed as well. Accordingly, departures may be made from the particular embodiments disclosed herein without departing from the scope of the concepts provided herein.

What is claimed is:

1. An object tracking system, comprising:
a pair of vertical camera arrays disposed on or adjacent to a first face of a playing space, wherein each vertical camera array comprises two cameras arranged vertically within the vertical camera array, and cameras of the pair of vertical camera arrays are time-synchronized;
a processor communicatively coupled to the cameras of the pair of vertical camera arrays; and
a non-transitory computer-readable storage medium having stored thereon logic that, when executed by the processor, causes performance of operations comprising:
obtaining a set of images from the cameras of the vertical camera arrays, wherein the set of images comprises a first sequence of image pairs captured at successive times by the cameras of a first vertical camera array of the vertical camera arrays, and a second sequence of image pairs captured at the successive times by the cameras of a second vertical camera array of the vertical camera arrays;
identifying an object in the set of images based on object recognition processing;
determining whether the object is disposed in a first portion of the playing space or in a second portion of the playing space, wherein the playing space comprises a floor surface area proximate to the first face, and the first portion and the second portion divide the floor surface area along a midline perpendicular to a midpoint of the first face;
selecting either the first sequence of image pairs or the second sequence of image pairs based on the determination of whether the object is disposed in the first portion of the playing space or the second portion of the playing space; and
tracking a location of the object within the playing space over time using the selected sequence of image pairs, wherein the tracking comprises triangulating the location of the object at one of the successive times.

2. The object tracking system of claim 1, wherein the pair of vertical camera arrays includes a first vertical camera array and a second vertical camera array,
the first vertical camera array is disposed adjacent to the first face of the playing space on a side of the midline corresponding to the first portion of the playing space,
the second vertical camera array is disposed adjacent to the first face of the playing space on a side of the midline corresponding to the second portion of the playing space,
the first sequence of image pairs are captured by the first vertical camera array and include images of the second portion of the playing space, and
the second sequence of image pairs are captured by the second vertical camera array and include images of the first portion of the playing space.

3. The object tracking system of claim 1, wherein each vertical camera array additionally comprises a third camera vertically positioned between the two cameras of the vertical camera array, and the operations further comprise:
obtaining a second set of images from the third cameras of the vertical camera arrays, the second set of images comprising replay image pairs captured at the successive times by the third cameras;
stitching at least some of the replay image pairs together, resulting in a set of panoramic replay images; and
displaying the set of panoramic replay images as a video on a screen of the object tracking system.

4. The object tracking system of claim 1, wherein each of the cameras of each vertical camera array is disposed such that a wider dimension of an aspect ratio of the camera is vertical, where the aspect ratio of the camera includes a wider dimension and a perpendicular less-wide dimension, and each of the cameras of each vertical camera array includes in a respective field of view at least part of a floor surface area of the playing space and at least part of a ceiling surface area of the playing space.

5. The object tracking system of claim 1, wherein the processor and the non-transitory computer-readable storage medium are components of a ruggedized computing device disposed proximate to the vertical camera arrays, the processor comprises a central processing unit (CPU) and a plurality of graphics processing units (GPUs), and the cameras of the vertical camera arrays are physically wired to the computing device.

6. The object tracking system of claim 1, wherein the object recognition processing comprises applying the set of images to an artificial intelligence (AI) classifier model trained on historic images taken by the cameras of the vertical camera arrays, resulting in an image segmentation of the object within at least some images of the set of images.

7. The object tracking system of claim 1, wherein the cameras of the vertical camera arrays are angled towards a point on the midline of the floor surface area such that fields of view of the cameras overlap.

8. The object tracking system of claim 1, wherein triangulating the location of the object at one of the successive times comprises:
applying a particular image pair, from the selected sequence of image pairs, that corresponds to the one of the successive times, to an artificial intelligence (AI) classifier model, resulting in image segmentations of the object and one or more points of a body, wherein the one or more points of the body comprise at least one of a head, a hand, and a foot; and
removing an outlier from a set of image segmentations identifying the object based on the image segmentations of the one or more points of the body.

9. The object tracking system of claim 1, wherein each vertical camera array comprises a rigid body to which each camera of the vertical camera array is secured such that the camera cannot move independently of the rigid body.

10. The object tracking system of claim 1, further comprising:
a plurality of modular structural components that, when assembled, secure the vertical camera arrays at a particular elevation above the playing space and at a particular distance from one another.

11. The object tracking system of claim 1, further comprising:
an object-throwing machine disposed proximate to the first face of the playing space; and
a screen proximate to the first face and directed towards the playing space, wherein the pair of vertical camera arrays are on either side of the screen, and the screen comprises a digital screen or a projector screen.

12. The object tracking system of claim 1, wherein the playing space is at least in part defined by the first face and two walls that form two corners with the first face, and the vertical camera arrays are disposed proximate to the two corners.

13. The object tracking system of claim 1, wherein the object is a soccer ball.

14. An object tracking method, comprising:
obtaining a set of images from cameras of a pair of vertical camera arrays, wherein the pair of vertical camera arrays is disposed on or adjacent to a first face of a playing space, each vertical camera array comprises two cameras arranged vertically within the vertical camera array, wherein cameras of the pair of vertical camera arrays are time-synchronized, and the set of images comprises a first sequence of image pairs captured at successive times by cameras of a first vertical camera array of the vertical camera arrays, and a second sequence of image pairs captured at the successive times by cameras of a second vertical camera array of the plurality of vertical camera arrays;
identifying an object in the set of images based on object recognition processing;
determining whether the object is disposed in a first portion of the playing space or in a second portion of the playing space, wherein the playing space comprises a floor surface area proximate to the first face, and the first portion and the second portion divide the floor surface area along a midline perpendicular to a midpoint of the first face;
selecting either the first sequence of image pairs or the second sequence of image pairs based on the determination of whether the object is disposed in the first portion of the playing space or the second portion of the playing space; and
tracking a location of the object within the playing space over time using the selected sequence of image pairs, wherein the tracking comprises triangulating the location of the object at one of the successive times.

15. The object tracking method of claim 14, wherein each vertical camera array additionally comprises a third camera vertically positioned between the two cameras of the vertical camera array, and the method further comprises:
obtaining a second set of images from the third cameras of the vertical camera arrays, the second set of images comprising replay image pairs captured at the successive times by the third cameras;
stitching at least some of the replay image pairs together, resulting in a set of panoramic replay images; and
displaying the set of panoramic replay images as a video on a screen.

16. The object tracking method of claim 14, wherein each of the cameras of each vertical camera array is disposed such that a wider dimension of an aspect ratio of the camera is vertical, and each of the cameras of each vertical camera array includes in a respective field of view at least part of a floor surface area of the playing space and at least part of a ceiling surface area of the playing space.

17. The object tracking method of claim 14, wherein the object recognition processing comprises applying the set of images to an artificial intelligence (AI) classifier model trained on historic images taken by the cameras of the vertical camera arrays, resulting in an image segmentation of the object within at least some images of the set of images.

18. The object tracking method of claim 14, wherein triangulating the location of the object at one of the successive times comprises:
applying a particular image pair, from the selected sequence of image pairs, that corresponds to the one of the successive times, to an artificial intelligence (AI) classifier model, resulting in image segmentations of the object and one or more points of a body, wherein the one or more points of the body comprise at least one of a head, a hand, and a foot; and
removing an outlier from a set of image segmentations identifying the object based on the image segmentations of the one or more points of the body.

19. The object tracking method of claim 14, wherein the pair of vertical camera arrays includes a first vertical camera array and a second vertical camera array,
the first vertical camera array is disposed adjacent to the first face of the playing space on a side of the midline corresponding to the first portion of the playing space,
the second vertical camera array is disposed adjacent to the first face of the playing space on a side of the midline corresponding to the second portion of the playing space,
the first sequence of image pairs are captured by the first vertical camera array and include images of the second portion of the playing space, and
the second sequence of image pairs are captured by the second vertical camera array and include images of the first portion of the playing space.

20. The object tracking method of claim 14, wherein each vertical camera array comprises a rigid body to which each camera of the vertical camera array is secured such that the camera cannot move independently of the rigid body.
